(19) United States
(12) Patent Application Publication
(10) Pub. No.: US 2017/0165997 A1
(43) Pub. Date: Jun. 15, 2017

(54) SECURITY DEVICE AND METHOD OF MANUFACTURE THEREOF

(71) Applicant: DE LA RUE INTERNATIONAL LIMITED, Basingstoke, Hampshire (GB)

(72) Inventor: Brian William HOLMES, Fleet (GB)

(73) Assignee: DE LA RUE INTERNATIONAL LIMITED, Basingstoke, Hampshire (GB)

(21) Appl. No.: 15/325,830

(22) PCT Filed: Jul. 28, 2015
(86) PCT No.: PCT/GB2015/052182

§ 371 Date: Jan. 12, 2017

(30) Foreign Application Priority Data
Jul. 30, 2014 (GB) 1413473.8

(51) Int. Cl. B42D 25/355; B42D 25/351; B42D 25/21; B42D 25/425; B42D 25/45; B42D 25/342; B42D 25/324; B42D 25/373

(52) U.S. Cl. CPC B42D 25/355; B42D 25/324; B42D 25/351; B42D 25/373; B42D 25/425; B42D 25/45; B42D 25/342; B42D 25/21

(57) ABSTRACT

A security device including a transparent substrate having opposing first and second surfaces; a first focusing element array disposed on the first surface of the transparent substrate; a second focusing element array disposed on the second surface of the transparent substrate; a first image array disposed on or in the transparent substrate in a first image array plane and configured to co-operate with the first focusing element array to exhibit an optically variable effect when viewed from a first side of the security device; and a second image array disposed on or in the transparent substrate in a second image array plane configured to co-operate with the second focusing element array to exhibit an optically variable effect when viewed from a second side of the security device. At least the first image array is configured to exhibit a first static macroimage when viewed from the second side of the device.

This invention relates to security devices, for example for use on documents of value such as banknotes, cheques, passports, identity cards, certificates of authenticity, fiscal stamps and other secure documents. Methods of manufacturing such security devices are also disclosed.

Articles of value, and particularly documents of value such as banknotes, cheques, passports, identification documents, certificates and licenses, are frequently the target of counterfeiters and persons wishing to make fraudulent copies thereof and/or changes to any data contained therein. Typically such objects are provided with a number of visible security devices for checking the authenticity of the object. Examples include features based on one or more patterns such as microtext, fine line patterns, latent images, venetian blind devices, lenticular devices, moiré interference devices and moiré magnification devices, each of which generates a secure visual effect. Other known security devices include holograms, watermarks, embossings, perforations and the use of colour-shifting or luminescent/fluorescent inks. Common to all such devices is that the visual effect exhibited by the device is extremely difficult, or impossible, to copy using available reproduction techniques such as photocopying. Security devices exhibiting non-visible effects such as magnetic materials may also be employed.

One class of security devices are those which produce an optically variable effect, meaning that the appearance of the device is different at different angles of view. Such devices are particularly effective since direct copies (e.g. photocopies) will not produce the optically variable effect and hence can be readily distinguished from genuine devices. Optically variable effects can be generated based on various different mechanisms, including holograms and other diffractive devices, and also devices which make use of focusing elements such as lenses, including moiré magnifier devices, integral imaging devices and so-called lenticular devices. Moiré magnifier devices (examples of which are described in EP-A-1695121, WO-A-94/27254, WO-A-2011/107782 and WO2011/107783) make use of an array of focusing elements (such as lenses or mirrors) and a corresponding array of microimage elements, wherein the pitches of the focusing elements and the array of microimage elements and/or their relative locations are mismatched with the array of micro-focusing elements such that a magnified version of the microimage elements is generated due to the moiré effect. Each microimage element is a complete, miniature version of the image which is ultimately observed, and the array of focusing elements acts to select and magnify a small portion of each underlying microimage element, which portions are combined by the human eye such that the whole, magnified image is visualised. This mechanism is sometimes referred to as “synthetic magnification”. The magnified array appears to move relative to the device upon tilting and can be configured to appear above or below the surface of the device itself.

Integral imaging devices are similar to moiré magnifier devices in that an array of microimage elements is provided under a corresponding array of lenses, each microimage element being a miniature version of the image to be displayed. However here there is no mismatch between the lenses and the microimages. Instead a visual effect is created by arranging for each microimage to be a view of the same object but from a different viewpoint. When the device is tilted, different ones of the images are magnified by the lenses such that the impression of a three-dimensional image is given.

Lenticular devices on the other hand do not rely upon magnification, synthetic or otherwise. An array of focusing elements, typically cylindrical lenses, overlies a corresponding array of image elements, or “slices”, each of which depicts only a portion of an image which is to be displayed. Image slices from two or more different images are interleaved and, when viewed through the focusing elements, at each viewing angle, only selected image slices will be directed towards the viewer. In this way, different composite images can be viewed at different angles. However it should be appreciated that no magnification typically takes place and the resulting image which is observed will be of substantially the same size as that to which the underlying image slices are formed. Some examples of lenticular devices are described in U.S. Pat. No. 4,892,336, WO-A-2011/051669, WO-A-2011051670, WO-A-2012/027779 and U.S. Pat. No. 6,856,462. More recently, two-dimensional lenticular devices have also been developed and examples of these are disclosed in British patent application numbers 1313362.4 and 1313363.2. Lenticular devices have the advantage that different images can be displayed at different viewing angles, giving rise to the possibility of animation and other striking visual effects which are not possible using the moiré magnifier or integral imaging techniques.

By their nature, the optically variable effects displayed by devices such as moiré magnifiers, integral imaging devices and lenticular devices are usually visible from only one side of the device. This renders such devices non-optimal for use in transparent windows of security documents (as are increasingly widespread, especially but not exclusively in documents based on polymer substrates, such as polymer banknotes), since from the reverse side there is no secure visible effect. Typically, the image array (made up of image elements in the case of a lenticular device or of microimages in the case of a moiré magnifier or an integral imaging device) on the reverse side of the device appears as a visually uniform, semi-transparent print region since the components of the image array are too small to be resolved by the naked eye.

Some attempts to address this problem include a lenticular device disclosed in U.S. Pat. No. 4,892,336 in which an image element array is sandwiched between two lens arrays such that the same lenticular effect can be viewed from either side. US-A-2008/0160226 discloses a dual-sided moiré magnifier device in which a first microimage array and a second microimage array are provided on either side of a masking layer and generate magnified versions thereof when viewed via respective lens arrays provided on both sides of the device. The masking layer and second microimage array are only provided in selected regions of the device and, where these are absent, the lens array arranged to magnify the second microimage array is able to magnify the first microimage array instead, since the two microimage arrays are located in closely adjacent planes. In this way the optically variable effect generated by the first microimage array is visible from one side of the device against a background defined by the masking layer, and from the other side of the device the optically variable effects of both the first and second microimage arrays are visible.

In accordance with the present invention, a security device comprises:
a transparent substrate having opposing first and second surfaces;
a first focusing element array disposed on the first surface of the transparent substrate;
a second focusing element array disposed on the second surface of the transparent substrate;
a first image array disposed on or in the transparent substrate in a first image array plane and configured to co-operate with the first focusing element array to exhibit an optically variable effect when viewed from a first side of the security device; and
a second image array disposed on or in the transparent substrate in a second image array plane, different from the first image array plane, the second image array being configured to co-operate with the second focusing element array to exhibit an optically variable effect when viewed from a second side of the security device;
wherein at least the first image array is further configured to exhibit a first static macroimage when viewed from the second side of the device.

By providing first and second image arrays which co-operate with corresponding focusing element arrays to generate optically variable effects whilst at the same time at least the first image array exhibits a static macroimage when viewed without the benefit of the corresponding focusing array (i.e. from the other side of the device) in this way, a dual-sided effect with strong visual impact is achieved. When viewed from the first side of the device, the first image array will exhibit an optically variable effect as a result of the interaction between that array and the first focusing element array. Meanwhile, the second image array will not exhibit an optically variable effect of this sort (i.e. it will appear static, if it is apparent to the viewer at all, although it could exhibit an iridescence or colour shift if it is formed from such a material). The contrast between the appearance of the first and second image arrays—one optically variable and the other static—provides a memorable and easily describable effect. When the device is viewed from the second side of the device, the effects are reversed. Now, the first image array appears as a static macroimage—that is, it appears optically inactive, but due to its configuration it will appear as a recognisable macroimage, i.e. one which is visible to the naked eye without the need for any magnification and/or spatial filtering as would be performed by a co-operating focusing element array—whilst the second image array becomes optically active as a result of its co-operation with the second focusing element array. Again the optically inactive static macroimage could possess an inherent iridescence or colourshift, but the form of the macroimage itself, i.e. its shape, size and position, will be invariable upon tilting. Thus, not only is an optically variable effect exhibited by both sides of the device but the overall effect is counter-intuitive, and therefore memorable, since each image element array will appear to taken on different properties (static vs. optically active) when the device is turned over.

In some preferred embodiments, only one of the image arrays presents a macroimage when viewed without the benefit of the corresponding focussing element array (i.e. when static). However, in particularly preferred implementations, the second image array is also further configured to exhibit a second static macroimage when viewed from the first side of the device. Having both image arrays present static macroimages (one viewable from each side of the device) enhances the visual complexity of the device and hence increases the security level.

It will be appreciated that the transparent substrate could be monolithic or could be formed of multiple layers, with the image arrays disposed on either the outer surfaces of the substrate or on internal layer interfaces as discussed further below. The term “transparent” means that light is transmitted through the substrate with low optical scattering so that the image arrays can be viewed through the substrate with minimal obscuration. However, the substrate can optionally be tinted with a visible or non-visible (e.g. fluorescent) additive if desired.

The first and second image array planes will preferably be substantially parallel to one another and spaced from one another in the direction normal to both planes. That is, the two image array planes are preferably non-intersecting planes.

Each of the image array planes is located such that it will only co-operate with one of the first and second focusing element arrays, and not both, in order that it appears static from one side of the device and optically variable from the other. Thus, preferably, the first image array plane is located inside the focal range of the first focussing element array and outside the focal range of the second focussing element array, and the second image array plane is located inside the focal range of the second focussing element array and outside the focal range of the first focussing element array. By “focal range” it is meant the range of distances from the respective focussing element array (measured from an appropriate reference point on the lens which we choose to call its optical centre (but it could be the sagittal peak of the lens) within which the focusing element array will be able to generate an acceptably focussed image of the image array. The action of the lens is to converge the incident light rays to, ideally, a common point (the “focal point”) or, in the case of a cylindrical lens, a common line. The distance the optical centre of the lens to this focal point or line is the “focal length”, i.e. the distance between the optical centre of the lens elements which constitute the lens array and the point at which parallel rays of light are brought to sharpest focus or convergence. Due to lens aberration, this focal line or point has a finite width in the focal plane. In order to achieve an acceptably focussed image of the image array, in the case of a lenticular-type device (comprising interlaced images), the width of the focal line or point is desirably arranged to be smaller than the width of each image element such that each lens samples only one image element. At locations away from the focal length (towards or away from the lenses), the line or point of convergence widens. Therefore, in the case of lenticular devices, the focal range is the range of distances from the focussing element array over which the width of the line or point of convergence does not substantially exceed the width of the image elements. By definition, the focal length will be inside the focal range of the focussing element array. For high contrast switching effects this is a strict requirement whereas for multi-channel animation and 3D effects the visual effect of the line of convergence exceeding the strip width is less adverse. For moiré magnifier and integral imaging devices, the focal line or point should preferably be less than the width of each microimage in order to achieve an acceptably focussed image of the image array.

In particularly preferred embodiments, the first image array plane is located within +/−10 microns of the focal point of the first focussing element array, preferably within +/−5 microns, and the second image array plane is located within +/−10 microns of the focal point of the second focussing element array, preferably within +/−5 microns.

Advantageously, the first image array plane is located closer (in terms of the direction normal to the plane of the substrate) to the second focusing element array than to the first focusing element array, and the second image array plane is located closer to the first focusing element array than to the second focusing element array. This allows for the overall thickness of the device to be kept small, since the optical paths between each image array and its co-operating focusing element array are effectively overlapped, at least partially, in the thickness direction. In particularly preferred implementations, the first image array plane is the second surface of the substrate, and the second image array plane is the first surface of the substrate. Thus, the optical paths between each image array and its co-operating focusing element array fully overlap one another in the thickness direction.

Preferably, the focal length of the first focusing element array is substantially equal to the focal length of the second focusing element array. However this is not essential since each image array can be positioned at a different distance from its co-operating focusing element array, e.g. through the use of a multi-layered transparent substrate. Nonetheless, it is preferred that the focal length of the first focusing element array and/or of the second focusing element array is greater than half the thickness of the transparent substrate, and preferably is substantially equal to the thickness of the substrate, in order to allow for overlapping of the optical paths as discussed above.

The first and second focusing element arrays could be disposed on the respective first and second surfaces of the transparent substrate in laterally spaced regions of the device, with no overlap. In this case the first image array would need to be provided at least in the same region of the device as the first focusing element array in order to achieve the stated co-operative visual effect, and likewise the second image array would need to be provided at least in the same region of the device as the second focusing element array. From the first side of the device, the first image array would exhibit its optically variable effect in combination with the first focussing element array as previously described and the second image array would be viewed directly (i.e. with no focussing elements between it and the viewer), whereby its static appearance (preferably a static macroimage) would be visible, again as previously described. The reverse would be seen when viewed from the second side.

However, in preferred embodiments, the first and second focusing element arrays overlap one another at least partially, preferably fully. In this way the two focusing element arrays can if desired be applied continuously over the whole of each surface of the substrate without any need for registration (even coarse registration) between the focusing element arrays and the image arrays. The visual result will be the same because only one of the image element arrays will co-operate with each focusing element array to produce an optically variable effect. For example, when viewed from the first side of the device, as before the first image array will exhibit its optically variable effect in combination with the first focussing element array. Whilst the second image array will now be viewed through the first focussing element array, since it is not located in a position at which it can co-operate with that focussing element array (e.g. because it is located outside the focal range of that focussing element array), no optically variable effect will be exhibited and instead the second image array will appear static, preferably as a static macroimage, as previously described. Again, the reverse will be seen when the device is viewed from the second side.

In some preferred implementations, the first image array is laterally offset from the second image array such that the first and second image arrays do not overlap one another, or only partially overlap one another. For example, the first and second image arrays may appear alongside one another, as separate items or as two parts of one combined image. The first and second image arrays may be laterally spaced from one another or may abut one another. Arrangement such as these offer maximum design freedom in terms of the range of effects that each image array is configured to display, and the corresponding static macroimages, since each image array is located in a separate region of the device and hence neither will obscure visualisation of the other (except in any regions of partial overlap). Hence if desired each image array can have a high proportion of “coloured” (as opposed to transparent) elements.

Where the first and second image arrays are laterally offset, they could ultimately be displayed in different window regions of a security document, as discussed further below. However, more preferably, the first and second image arrays are located within the same, continuous transparent region of the security device. This allows the two image arrays to be more directly compared against one another.

In other preferred implementations, the first and second image element arrays overlap one another at least partially, preferably fully. This offers other distinct advantages: for example, one of the image element arrays can be configured to appear as a static “background” to the other as it exhibits its optically variable effect, or to provide visual reference points against which the effect can be compared. Moreover, the increased visual integration of the two image arrays enhances the unexpected visual impact since from one side the device will exhibit a first optically variable effect whereas from the other side the same device will exhibit a second optically variable effect which can be different, whereupon the behaviour of a single device appears to change upon turning it over.

Where the two image arrays overlap, it is desirable to ensure that neither obscures visualisation of the other. Therefore, preferably, the first and second image element arrays are semi-transparent such that each image element array can be viewed through the other. Semi-transparency may be achieved by selecting a low optical density of the “coloured” elements of the array, so that they remain non-opaque, and/or by selecting a design in which only a low or moderate proportion of each image element array is formed by “coloured” elements. For example, designs made up of fine lines or guilloches would be suitable, as would microimage arrays in which the microimages are coloured and arranged on a transparent background.

The static macroimage(s) displayed by at least the first image array (and preferably also the second image array) independently of the focussing element arrays could take any form which is recognisable as an image, e.g. an item of information, to the naked eye. In some preferred embodiments, the first and/or second static macroimage exhibits at least one item of information defined at least in part by the periphery of the respective first and/or second image array. For example, the image array could be made up of image elements or microimages too small to be resolved by the naked eye and thus appearing as a uniform area of colour, the periphery of which defines an information item such as a geometric shape. Thus the macroimage appears as a geometric shape in the colour of the image array, contrasted against the surrounding transparent substrate where the image array in question is absent.

Additionally or alternatively the first and/or second static macroimage may exhibit at least one item of information defined at least in part by a halftone image carried by variations across the respective first and/or second image array. For example, the image array could be provided across an area of unspecified periphery (which may or may not be visible in the final product), and exhibit a static microimage within the area covered by the image array, resulting from variations in the size, frequency and/or optical density of elements within the image array itself. The image array can in effect be laid down as a screened working, with the elements forming the image array constituting the screen elements. This approach can be used to convey more complex static macroimages, such as portraits or other multi-tonal graphics. If desired, the static macroimage can be conveyed by both the periphery of the image array and a halftone variation within the array, in combination.

The first and second static macroimages could take any desirable form, but if both first and second macroimages are provided, preferably they exhibit respective items of information which are the same (i.e. have the same semantic meaning, e.g. both are star symbols or both are the digit “5”), complementary (i.e. different but together form an item of information such as two portions of an image, e.g. “£” and “5”, forming “£5”, or “5” and “0” forming “50”) or conceptually linked (i.e. different but with an intelligible connection, e.g. a portrait of Queen Elizabeth II and “QEII”). Also preferably, the first and/or second static macroimage is symmetrical about at least one axis, more preferably about two orthogonal axes. In this way the appearance of the static macroimage remains the same from both sides of the device, to the extent it manifests in the optically variable effect generated when the image array is viewed in combination with its co-operating focusing element array.

Preferably, the first and/or second static macroimage exhibits at least one item of information comprising any of: alphanumeric text, a letter or number, a symbol, a portrait, a logo or another graphic.

The two image arrays may be formed in the same colour as one another, but in particularly preferred embodiments the first and second image arrays are of different colours from one another. This achieves a multi-coloured effect which further distinguishes the device from conventional devices. It should be noted that the term “colour” used here and throughout this disclosure encompasses not only conventional “colours” as may be laid down by inks or similar (including black) but also diffractive colours as may be formed by relief elements or metallic colours as result from forming the image array as a patterned metal layer, and also iridescent or variable-hue materials such as colour-shifting inks.

The optical variable effects generated by the co-operation of each image array and its respective focusing element array (also referred to as its “co-operating focusing element array”) can be based on any suitable mechanism, including moiré magnification, integral imaging or lenticular devices (interlacing). The optically variable effects exhibited by the first and second image arrays may be generated by the same mechanism as each other, or by different mechanisms (including any of those mentioned above). In one particularly preferred embodiment, both optically variable effects are lenticular effects. In another particularly preferred embodiment, both optically variable effects are moiré magnifier effects. In another particularly preferred embodiment, both optically variable effects are integral imaging effects. In another particularly preferred embodiment, the first optically variable effect is a lenticular effect and the second is a moiré magnifier effect, or vice versa. In another particularly preferred embodiment, the first optically variable effect is a lenticular effect and the second is an integral imaging effect, or vice versa. In another particularly preferred embodiment, the first optically variable effect is a moiré magnifier effect and the second is an integral imaging effect, or vice versa.

Hence, in some preferred embodiments, the first and/or second image array comprises an array of image elements configured such that each focusing element within the co-operating focusing element array can direct light from any one of a respective set of at least two image elements to the viewer, in dependence on the viewing angle, each image element within each set exhibiting a portion of a corresponding image whereby, depending on the viewing angle, the array of focusing elements directs light from selected image elements to the viewer, such that as the device is tilted different ones of the respective images are displayed sequentially by the selected image elements of each set in combination. Thus, in this case the optically variable effect exhibited by the first and/or second image array is a lenticular effect. Any number of different images could be interlaced in the manner described to achieve any desired visual effect upon tilting (whereupon the image array will appear to display one image after another). In particularly preferred examples, the first and/or second image array is configured to exhibit an animation effect in combination with the co-operating focusing element, preferably an expanding and/or contracting effect, or a motion effect, or a combination of the two. Such effects are preferred, as compared with morphing effects for instance, since the image array can be more readily adapted to display a distinct static macroimage.

In further preferred embodiments, the first and/or second image array comprises an array of substantially identical microimages, and the pitches of the focusing elements in the co-operating focusing element array and of the array of microimage elements and their relative orientations are such that the array of focusing elements co-operates with the array of microimage elements to generate a magnified version of the microimage elements due to the moiré effect. Thus, in this case the optically variable effect exhibited by the first and/or second image array is a moiré magnification effect. It should be noted that whilst the microimages within either one array should be substantially identical to each other in order to achieve the desired optically variable effect, they may vary in terms of size or optical density for instance, as may be required to form a half tone static macroimage. The array of microimages can be arranged relative to the co-operating focusing element array in such a way that the generated magnified image appears to lie in a plane above or below the plane of the substrate, which may optionally appear tilted or curved. Details of how to achieve such effects are disclosed in WO-A-2011/107782.

In still further preferred embodiments, the first and/or second image array comprises an array of microimages each depicting the same object from a different viewpoint, and the pitches and orientation of the focusing elements in the co-operating focusing element array and of the array of microimage elements are the same, such that the array of focusing elements co-operates with the array of microimage elements to generate a magnified, optically-variable version of the object. Thus, in this case the optically variable effect exhibited by the first and/or second image array is an integral imaging effect.

In all cases, the size and/or optical density of the image elements or microimages in the first and/or second image array may vary across the array to form a halftone static macroimage. For instance, exemplary techniques as to how this may be implemented in the case of a microimage array suitable for use as the image array in a moiré magnifier or integral imaging device are disclosed in WO-A-2013/056299.

The optically variable effects exhibited by the first and/or second image arrays in combination with the co-operating focusing element arrays may be exhibited upon tilting the device just one direction (i.e. a one-dimensional optically variable effect), or in other preferred implementations may be exhibited upon tilting the device in either of two orthogonal directions (i.e. a two-dimensional optically variable effect). If each optically variable effect operates in just one direction, these need not be the same. For example, the optically variable effect generated by the first image array may operate upon horizontal (left-right) tilting, whilst that generated by the second image array may operate upon vertical (up-down) tilting. One of the optically variable effects could be one-dimensional whilst the other is two-dimensional.

Advantageously, the first and/or second focussing element array comprises focusing elements adapted to focus light in one dimension, preferably cylindrical focusing elements, or adapted to focus light in at least two orthogonal directions, preferably spherical or aspherical focussing elements. The first and/or second focussing element array may comprises lenses, for example. In preferred embodiments, the focusing element array has a one- or two-dimensional periodicity in the range 5-200 microns, preferably 10-70 microns, most preferably 20-40 microns. Advantageously, wherein the focusing elements may be formed by a process of thermal embossing or cast-cure replication. Alternatively, printed focusing elements could be employed as described in U.S. Pat. No. 6,856,462.

The first and/or second focusing element array may or may not be registered to the co-operating image array (beyond the extent necessary to ensure at least partial overlap). For example, in the case of moiré magnifiers, no registration between the focussing elements and microimage array is essential, unless a particular degree of magnification is desired. This is because the degree of magnification is determined by the effective pitch difference between the two arrays and is not affected by registration. Note that any rotation of one array relative to the other effectively changes the relative pitch and therefore the magnification. Where the effect is generated by integral imaging, rotational registration is required between the focussing elements and image array, and translational registration is strongly preferred, although an acceptable image may still be achieved if the translational registration is not exact. Where the effect is formed by interlacing (lenticular devices), the orientation of the focussing element array and the image array should be matched but translational registration is not essential, but is desirable in some cases. If it is desired to reduce the effects of mis-registration, designs based on principles such as those disclosed in WO-A-2012/153106 or WO-A-2011/051668 may be employed. However in other cases, it may be preferable to require registration so as to increase the difficulty of counterfeiting. In such cases designs which make use of registration such as those disclosed in British patent application number 1313362.4 may be employed.

In some preferred embodiments, the image arrays are defined by inks, e.g. by printing. Conventional single-coloured inks can be used, but in some preferred embodiments at least one of the image array is formed of an iridescent or colour-shifting ink. Preferred printing techniques for forming the image arrays include those disclosed in WO-A-2008/000350, WO-A-2011/102800 and EP-A-2460667. Thus, the image arrays can be simply printed onto the substrate (or an internal layer thereof) although it is also possible to define the image arrays using a relief structure. This enables much thinner devices to be constructed which is particularly beneficial when used with security documents. Suitable relief structures can be formed by embossing or cast-curing into or onto a substrate. Of the two processes mentioned, cast-curing provides higher fidelity of replication.

A variety of different relief structures can be used as will described in more detail below. However, the image arrays could be created by embossing/cast-curing the images as diffraction grating structures. Differing parts of the image array could be differentiated by the use of differing pitches or different orientations of grating providing regions with a different diffractive colour. Alternative (and/or additional differentiating) image structures are anti-reflection structures such as moth-eye (see for example WO-A-2005/106601), zero-order diffraction structures, stepped surface relief optical structures known as Aztec structures (see for example WO-A-2005/115119) or simple scattering structures. For most applications, these structures could be partially or fully metallised to enhance brightness and contrast. Typically, the width of each image element or microimage may be less than 50 microns, preferably less than 40 microns, more preferably less than 20 microns, most preferably in the range 5 to 10 microns.

One or both of the image arrays could alternatively be formed of a patterned metal layer. For example, one particularly preferred method for forming a high resolution image array suitable for use in the presently disclosed devices is described in our British patent application no. 1510073.8. This involves exposing a resist layer on a metallised substrate to radiation which changes the solubility of the resist through a patterned mask which is carried, for example, on the surface of a cylinder. The exposure of the resist can therefore take place in a web-based process. After exposure, the substrate carrying the patterned resist is immersed in etchant leading to the selective dissolution of the metal layer in accordance with the desired pattern to form an image array. This has been found to achieve particularly high resolution.

It will be appreciate that the first and second image arrays need not be formed using the same technique, although this is preferred in many cases. For example, one of the image arrays could be formed using the above-described demetallisation technique whilst the other may be formed by printing or as a relief structure.

The present invention further provides a security article comprising a security device as described above, wherein the security article is preferably a security thread, strip, foil, insert, transfer element, label or patch. Such articles can be applied to or incorporated into documents of value using well known techniques, including as a windowed thread, or as a strip covering an aperture in a document.

Also provided is a security document comprising a security device as described above, wherein the security document is preferably a banknote, cheque, passport, identity card, driver's license, certificate of authenticity, fiscal stamp or other document for securing value or personal identity. The security document preferably includes at least one transparent window for display of the security element. Thus in some preferred embodiments, the security document has a transparent window within which both the first and the second image arrays are visible, from both sides of the document. This allows both image arrays to be arranged closely adjacent or overlapping one another. Alternatively, the security document may have a first transparent window within which the first image array is visible from both sides of the document, and a second transparent window spaced from the first within which the second image array is visible from both sides of the document.

Various constructions are possible. In one preferred implementation, the security document comprises a transparent document substrate which forms the transparent substrate defined above, and at least one opacifying layer disposed on the transparent document substrate so as to define one or more transparent windows within which the first and second image arrays are visible from both sides of the document. An example of such a security document would be a polymer banknote.

In another preferred implementation, the security document comprises a security article according as discussed above applied to or incorporated into a document substrate, the document substrate having one or more transparent windows therethrough within which the first and second image arrays are visible from both sides of the document. An example of such a security document would be a banknote based on a conventional paper or other non-transparent document substrate. The security article may be a thread which is incorporated into the document substrate in a windowed fashion so as to reveal the security device.

The present invention also provides a method of manufacturing a security device, comprising:
providing a transparent substrate having opposing first and second surfaces;
forming a first focusing element array on the first surface of the transparent substrate;
forming a second focusing element array on the second surface of the transparent substrate;
forming a first image array on or in the transparent substrate in a first image array plane and configured to co-operate with the first focusing element array to exhibit an optically variable effect when viewed from a first side of the security device; and
forming a second image array on or in the transparent substrate in a second image array plane, different from the first image array plane, the second image array being configured to co-operate with the second focusing element array to exhibit an optically variable effect when viewed from a second side of the security device;
wherein at least the first image array is further configured to exhibit a first static macroimage when viewed from the second side of the device.

The resulting security device provides all the advantages discussed above. The method can be adapted to incorporate any of the optional features mentioned above.

Examples of security devices, security articles and security documents in accordance with the present invention will now be described with reference to the accompanying drawings, in which:—

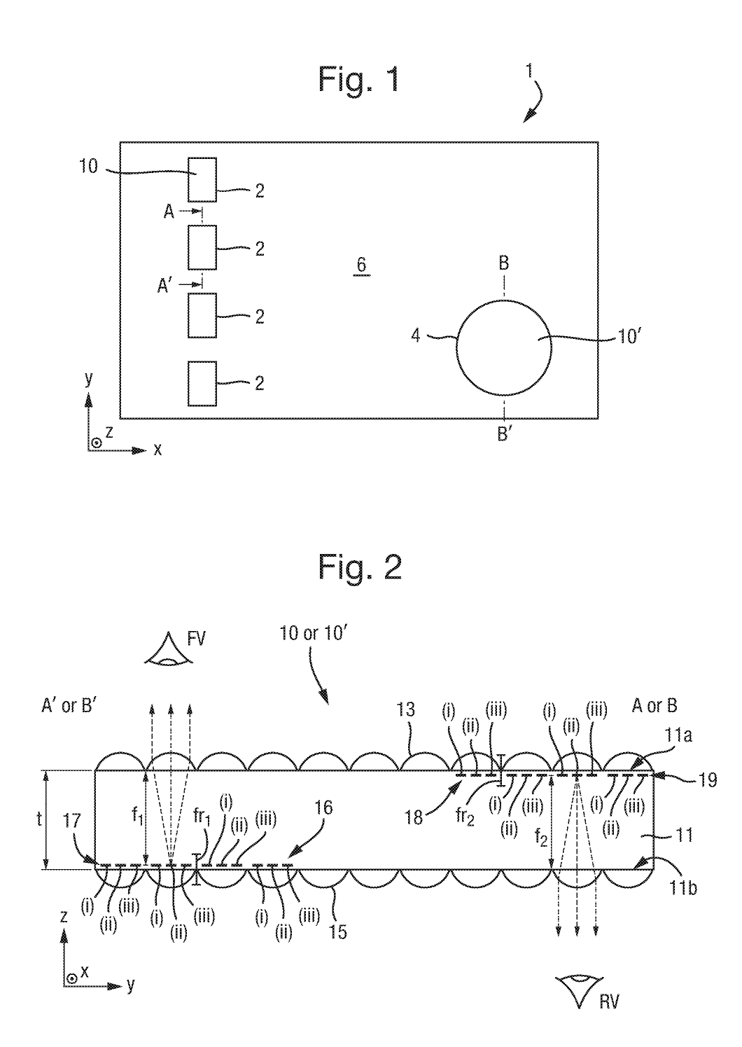

FIG. 1 shows an exemplary security document;

FIG. 2 shows a first embodiment of a security device, in cross-section;

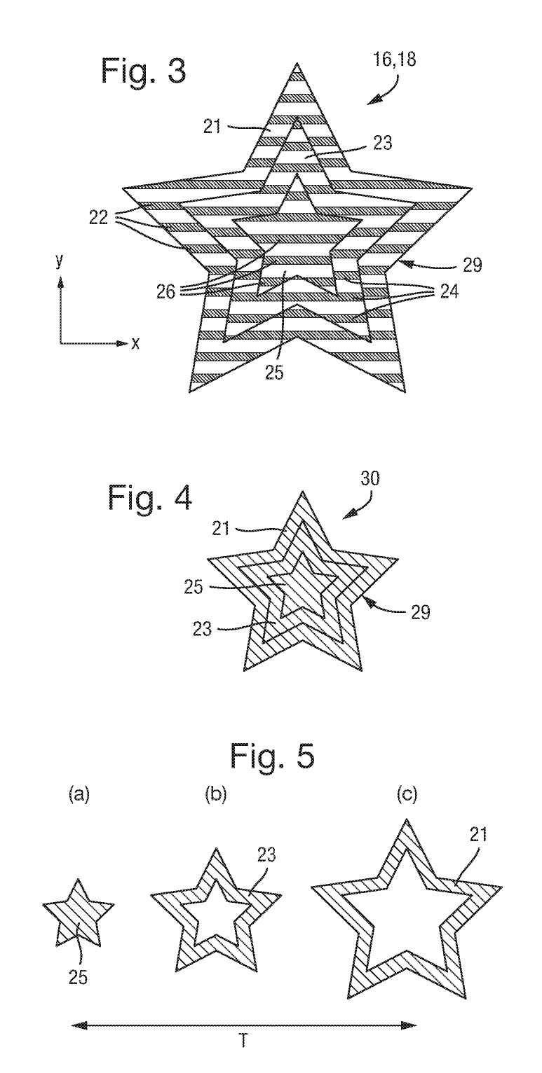

FIG. 3 shows a first example of an image array suitable for use in the security device of FIG. 2;

FIG. 4 shows the static macroimage exhibited by the image array of FIG. 3;

FIGS. 5(a), (b) and (c) show the optically variable appearance of the image array of FIG. 3, at three different viewing angles;

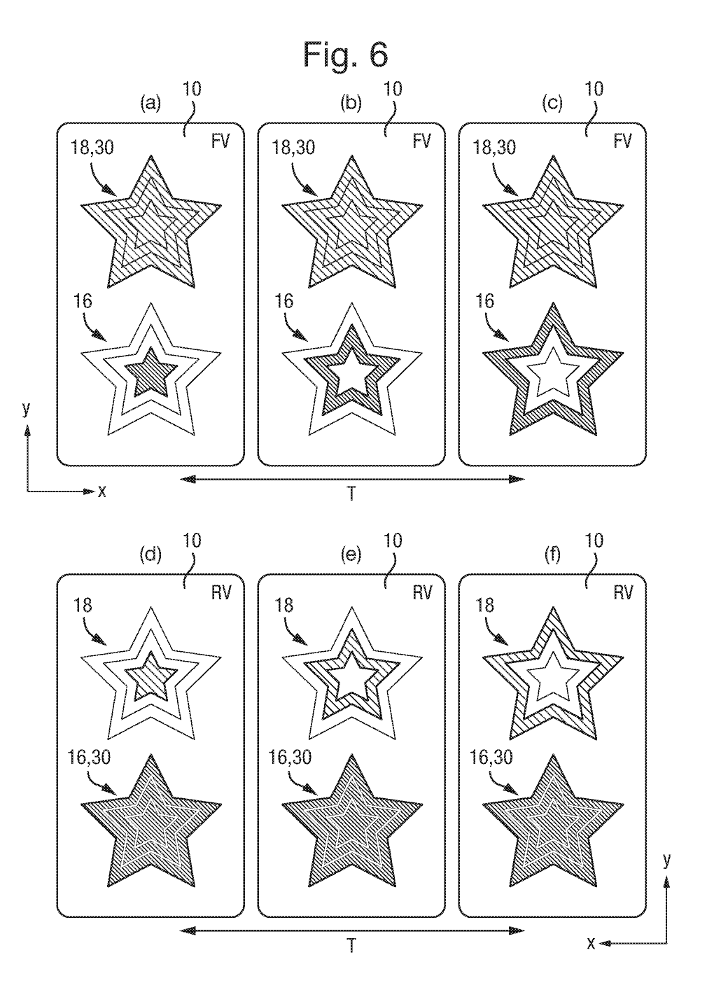

FIGS. 6(a), (b) and (c) show the front view appearance of the security device of FIG. 2 provided with image arrays as shown in FIG. 3, at three different viewing angles, while FIGS. 6(d), (e) and (f) show the rear view appearance of the same security device, at three different viewing angles;

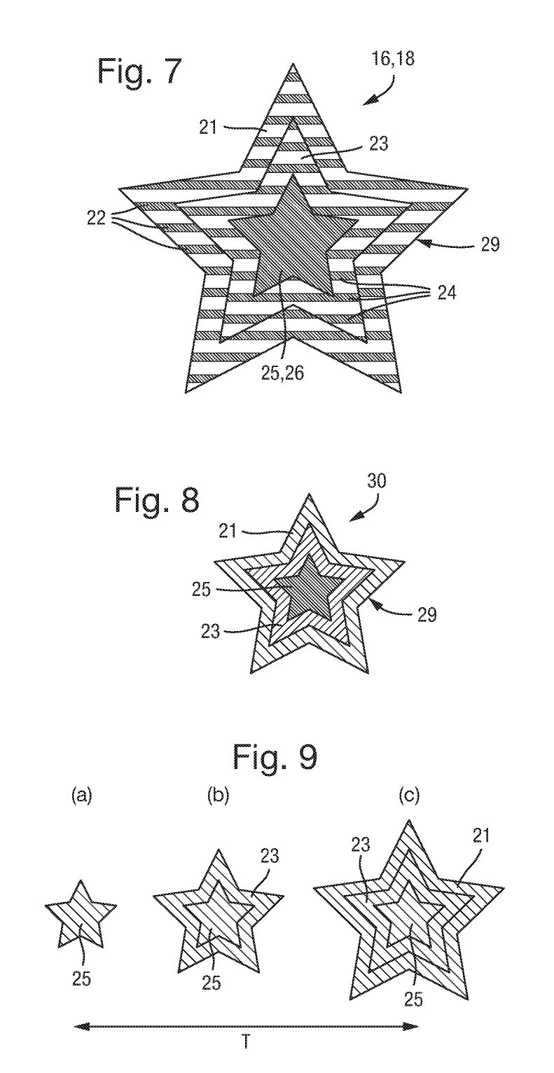

FIG. 7 shows a second example of an image array suitable for use in the security device of FIG. 2;

FIG. 8 shows the static macroimage exhibited by the image array of FIG. 7;

FIGS. 9(a), (b) and (c) show the optically variable appearance of the image array of FIG. 7, at three different viewing angles;

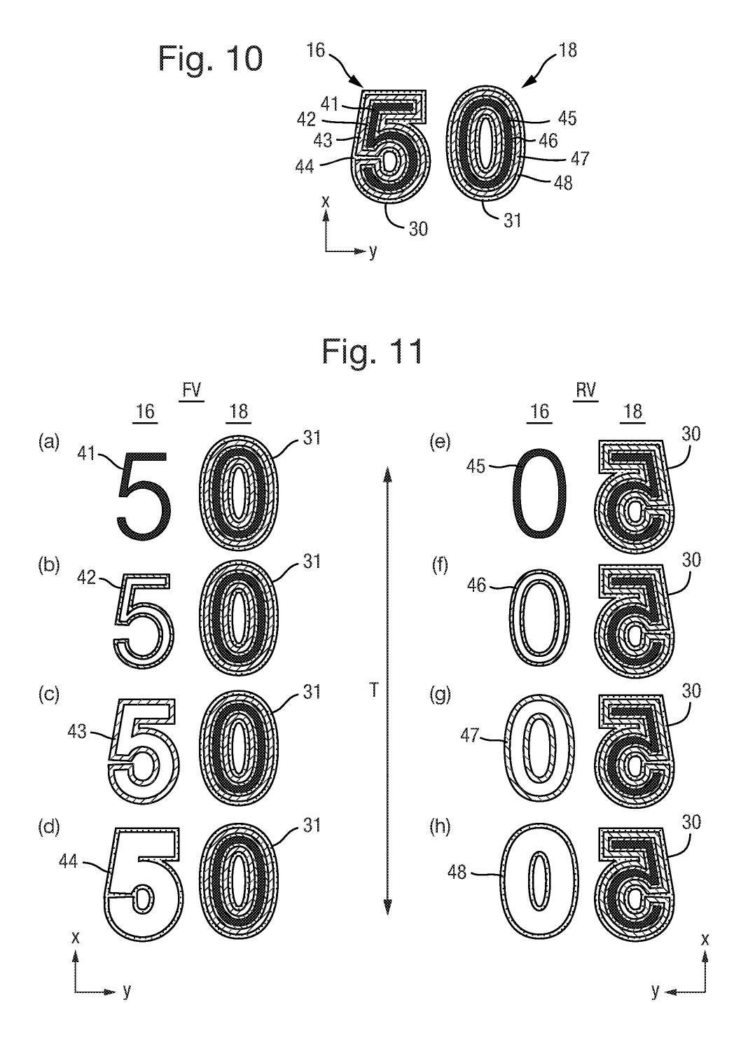

FIG. 10 shows a third example of first and second image arrays suitable for use in the security device of FIG. 2, depicting the front view of their macroimages,

FIGS. 11(a), (b), (c) and (d) show the front view appearance of the security device of FIG. 2 provided with image arrays as shown in FIG. 10, at four different viewing angles, while FIGS. 11(e), (f), (g) and (h) show the rear view appearance of the same security device, at four different viewing angles;

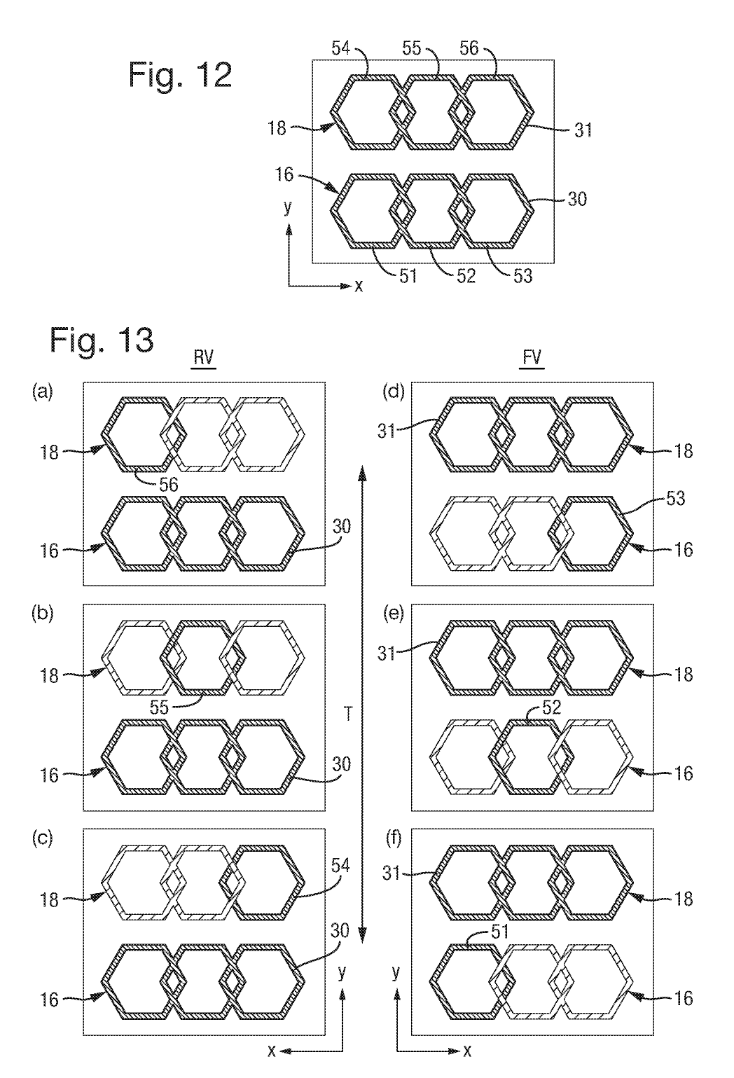

FIG. 12 shows a fourth example of first and second image arrays suitable for use in the security device of FIG. 2, depicting the front view of their macroimages;

FIGS. 13(a), (b) and (c) show the rear view appearance of the security device of FIG. 2 provided with image arrays as shown in FIG. 12, at three different viewing angles, while FIGS. 13(d), (e) and (f) show the front view appearance of the same security device, at three different viewing angles;

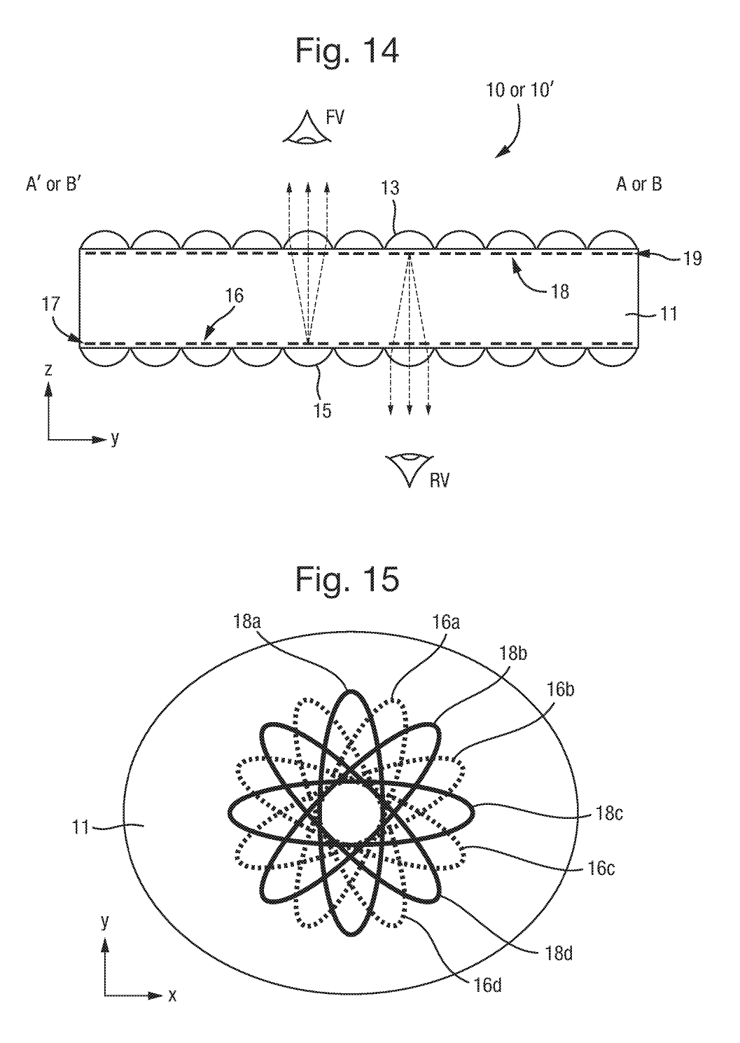

FIG. 14 shows a second embodiment of a security device, in cross-section;

FIG. 15 shows an example of first and second image arrays suitable for use in the security device of FIG. 14, depicting the front view of their macroimages;

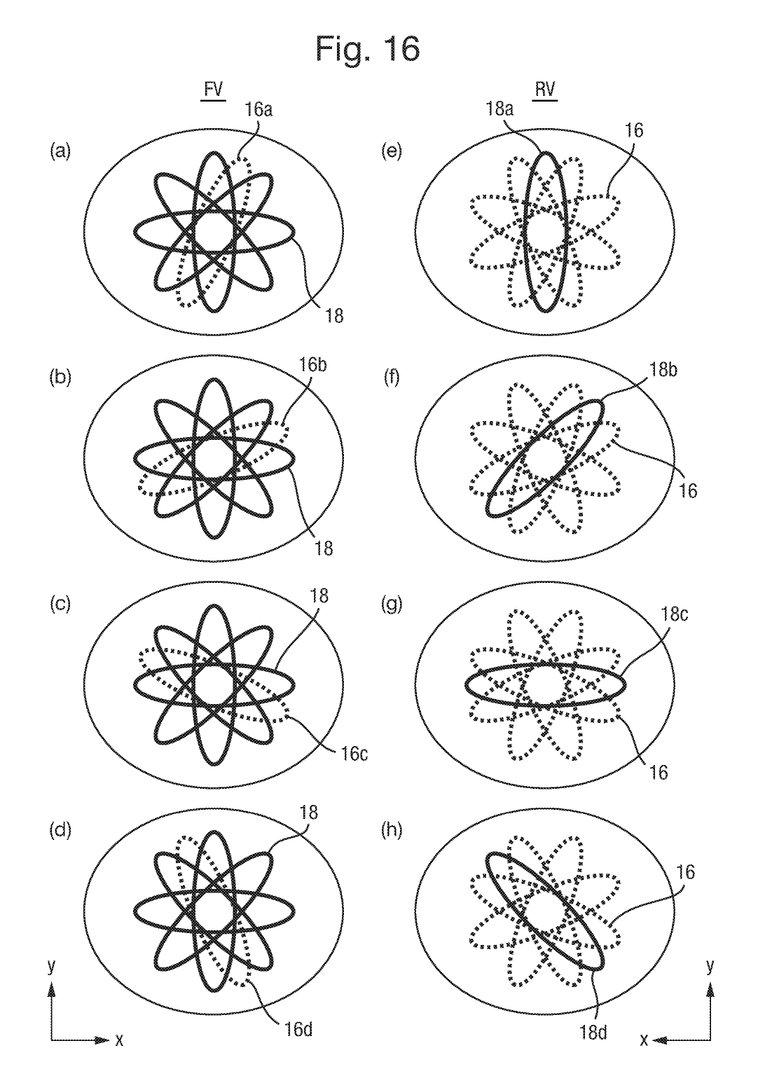

FIGS. 16(a), (b), (c) and (d) show the front view appearance of the security device of FIG. 14 provided with image arrays as shown in FIG. 15, at four different viewing angles, while FIGS. 16(e), (f), (g) and (h) show the rear view appearance of the same security device, at four different viewing angles;

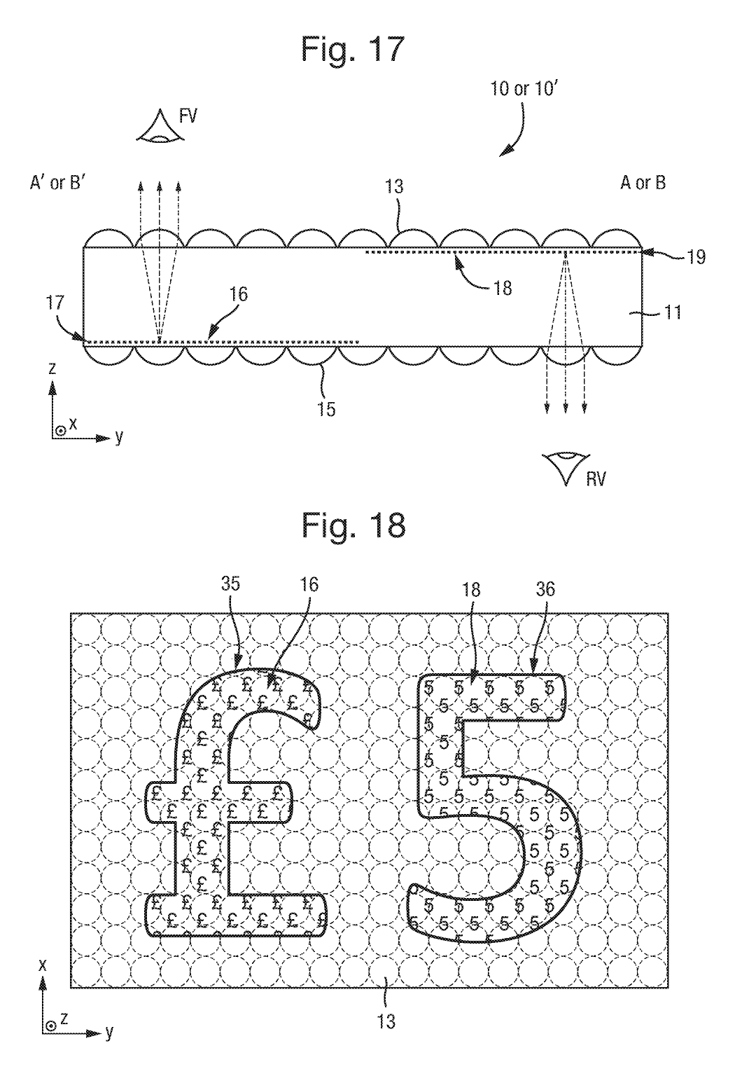

FIG. 17 shows a third embodiment of a security device, in cross-section;

FIG. 18 shows a front view of the security device of FIG. 17 and exemplary image arrays at an artificially large scale for clarity;

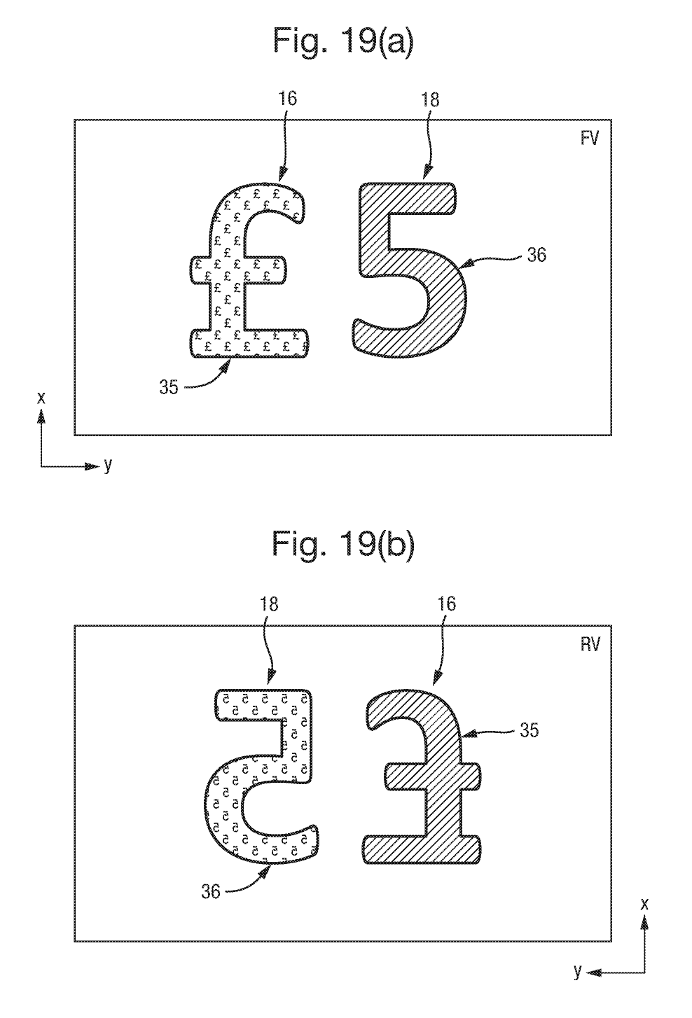

FIGS. 19(a) and (b) show, respectively, the front view appearance and the rear view appearance of the security device of FIG. 18;

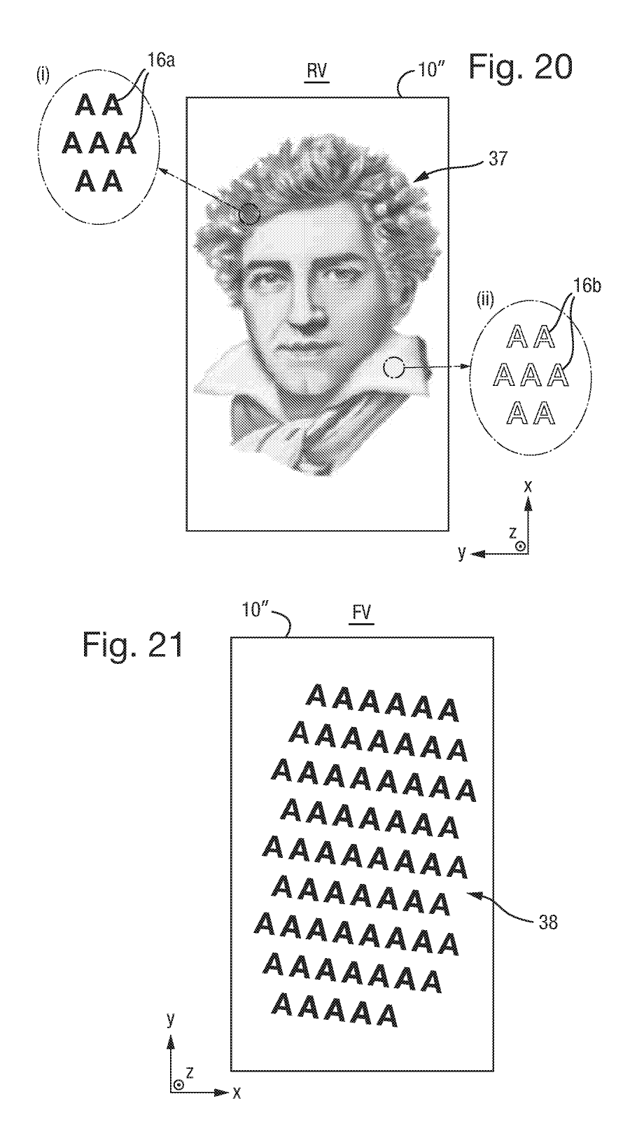

FIGS. 20 and 21 show a portion of the security device of FIG. 17 with another exemplary image array, FIG. 20 showing a static macroimage exhibited by the exemplary image array without magnification as viewed from one side of the device, plus two enlarged regions (i) and (ii), and FIG. 21 showing the magnified image array as viewed from the other side of the device;

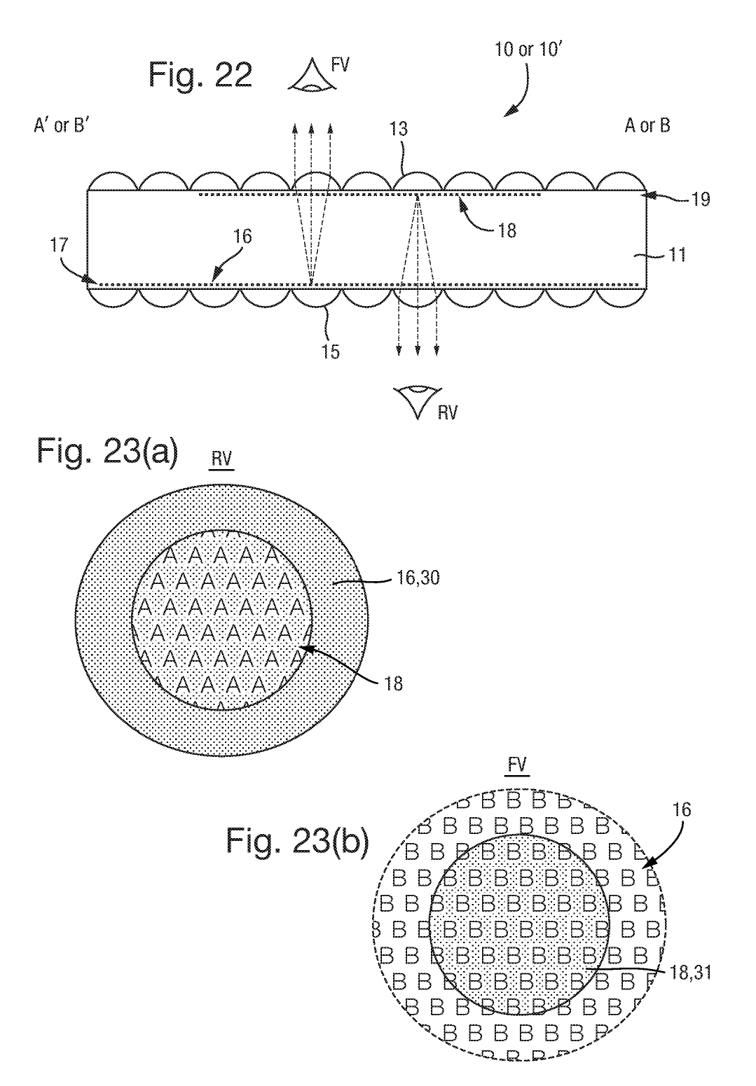

FIG. 22 shows a fourth embodiment of a security device, in cross-section;

FIGS. 23(a) and (b) show, respectively, the front view appearance and the rear view appearance of the security device of FIG. 22;

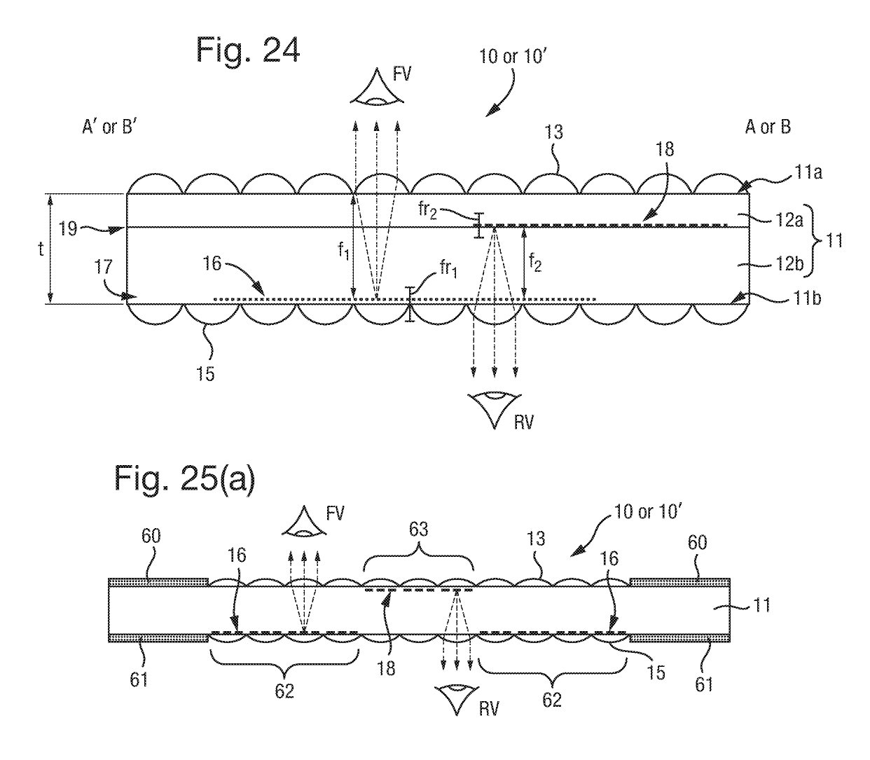

FIG. 24 shows a fifth embodiment of a security device, in cross-section;

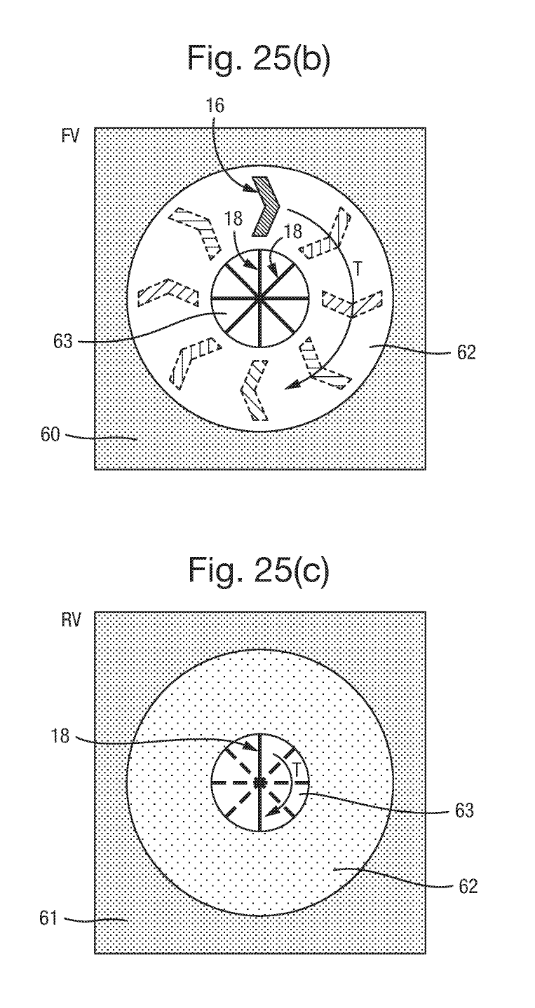

FIG. 25 shows a sixth embodiment of a security device, in (a) cross-section, (b) front view and (c) rear view;

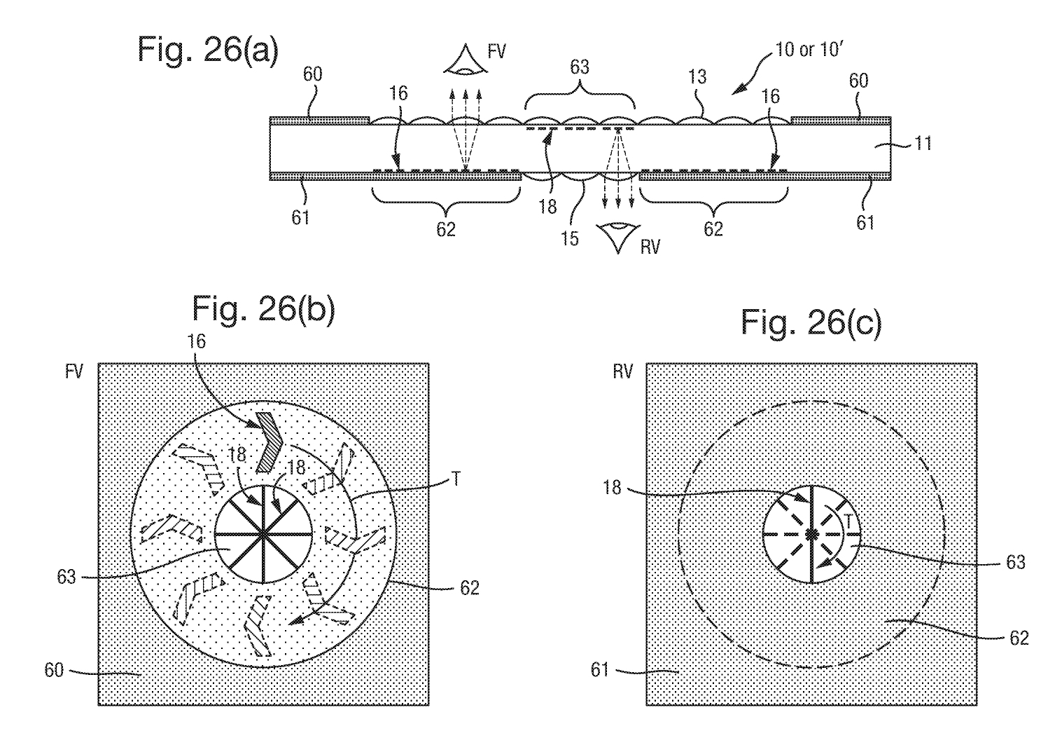

FIG. 26 shows a variation of the sixth embodiment, in (a) cross-section, (b) front view and (c) rear view;

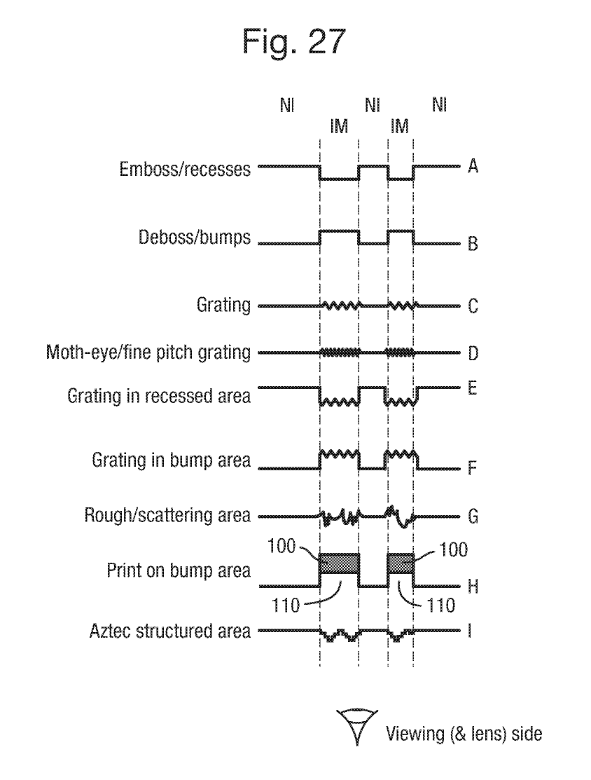

FIGS. 27a to 25i illustrate different examples of relief structures which may be used to define image arrays in accordance with the present invention;

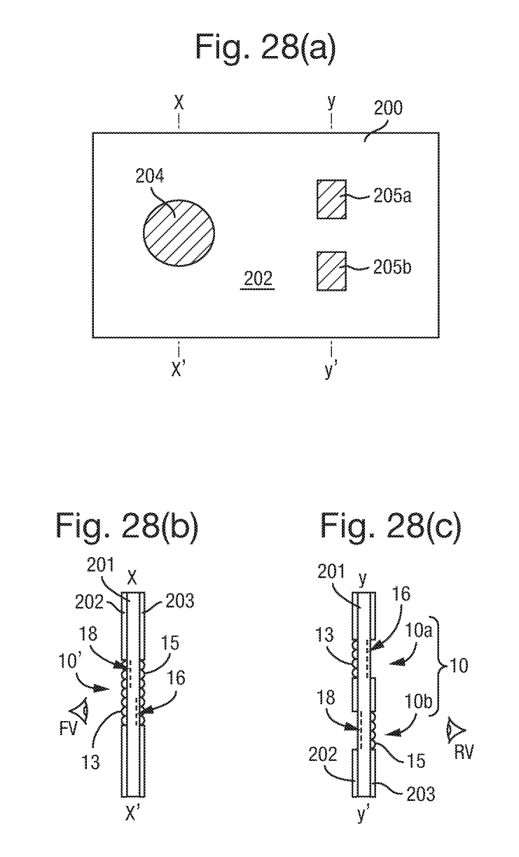

FIGS. 28, 29 and 30 show three exemplary articles carrying security devices in accordance with embodiments of the present invention (a) in plan view, and (b)/(c) in cross-section; and

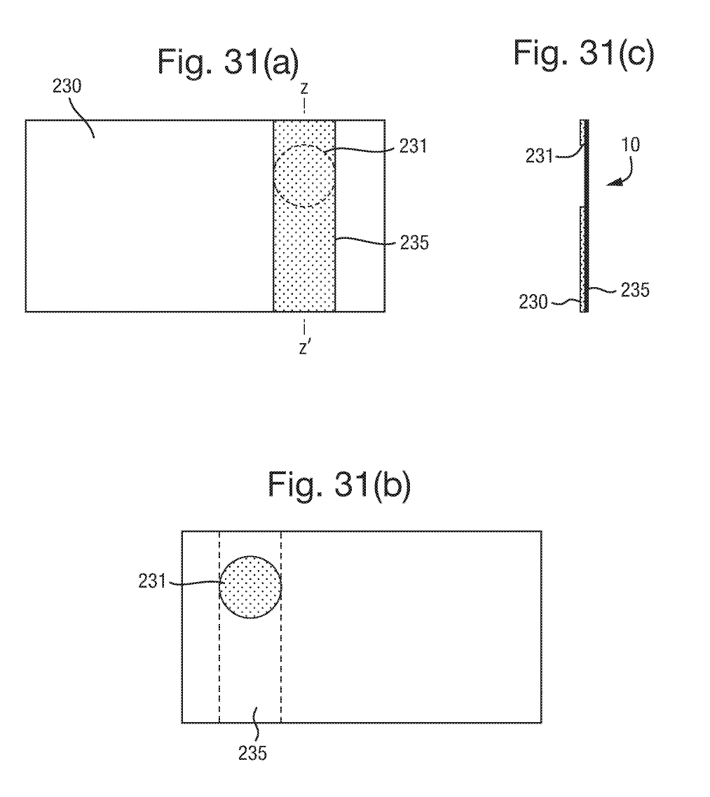

FIG. 31 illustrates a further embodiment of an article carrying a security device in accordance with the present invention, (a) in front view, (b) in back view and (c) in cross-section.

FIG. 1 illustrates schematically a banknote or other security document 1 having a first security device 10 carried on a security article such as a thread exposed at windows 2, and a further transparent window 4 in which a second security device 10′ may be disposed. The banknote 1 may be made of paper or polymer (such as bi-axially oriented polypropylene) and one or both of the security thread and window 4 incorporates a security device according to the invention. The banknote typically carries graphics such as security prints 6 across the remainder of its surface, surrounding the windows 2, 4.

FIG. 2 shows a first embodiment of a security device 10 (or 10′), in cross-section along the line A-A′ (or B-B′) shown in FIG. 1. A transparent substrate 11 (which may carry a coloured tint, provided it can still be seen-through) is provided with a first array of focusing elements 13 on its first surface 11a, and a second array of focusing elements 15 on its second surface 11b. In this example, both arrays of focusing elements 13, 15 comprise regular arrays of lenses which are adapted to focus light in one direction, such as cylindrical lenses. The long axes of the lenses in both arrays lie parallel to the x-axis in this example. A first image array 16 is provided on a first image array plane 17, which in this case corresponds to the second surface 11b of the transparent substrate 11 (the image array 16 is depicted as lying slightly inside the substrate 11 solely for clarity in this case, although as discussed below the image array can alternatively be formed internally to the substrate 11 if desired). A second image array 18 is provided on a second image array plane 19, which here corresponds to the first surface 11 a of the transparent substrate 11.

In this case, the lenses forming the first and second focusing element arrays 13, 15 are each configured to have substantially the same focal length (f₁, f₂, respectively), which is approximately equal to the thickness t of the transparent substrate 11. The first image array plane 17 lies within the focal range fr₁ of the first focusing element array 13, whilst outside that of the second focusing element array 15 (fr₂), and the second image array plane 19 lies within the focal range fr₂ of the second focusing element array 15, whilst outside that of the first focusing element array 13. Most preferably each image array 16, 18 lies substantially at the focal length f₁, f₂ of the corresponding focusing element array 13, 15 but acceptable results can still be achieved if the image array lies within a suitable tolerance of the focal length, e.g. to +/−10 microns or more preferably to +/−5 microns.

Each focusing element array 13, 15 will therefore be capable of directing light from only one of the image arrays 16, 18, and not both. Specifically, when the device is viewed from the front (“FV”=“front view” throughout this disclosure), the first focusing element array 13 will act to focus light from the first image array 16 to the viewer, giving rise to an optically variable effect as will be discussed further below. From the same viewpoint, whilst in this case the second image array 18 will also be observed through the first focusing element array 13 (since the first focusing element array overlaps the second image array 18), this will have no focusing effect since the second image array 18 is located outside the focal range of the first focusing element array 13. As such there is no co-operation between the first focusing element array 13 and the second image array 18, which appears static (i.e. optically inactive).

When the device 10 is viewed from the rear side (“RV”=“rear view” throughout this disclosure), the effects reverse. Now, the second focusing element array 15 will act to focus light from the second image array 18 to the viewer, giving rise to an optically variable effect as discussed below. Meanwhile, the first image array 16 will appear static since, whilst it is being observed through the second focusing element array 15, this has no effect since the first image array 16 is not within its focal range.

It will be understood from the above that the first image array 16 co-operates with only the first focusing element array 13 to exhibit an optically variable effect, whilst the second image array 18 co-operates with only the second focusing element array 15 to exhibit an optically variable effect. The focusing element array with which either one of the respective image arrays co-operates in this way is referred to for brevity below as the “co-operating” focusing element array.

It should also be noted that in this embodiment, the first and second image arrays do not overlap one another whilst the two focusing element arrays 13, 15 overlap one another and extend across both image arrays 16, 18. This is not essential. In this embodiment, the first focusing element array 13 could be provided only in the vicinity of the first image array 16, and the second focusing element array 15 could be provided only in the vicinity of the second image array 18. However, this will require at least coarse registration between the respective image arrays and their co-operating focusing element arrays so that each is present in the same region of the device.

Each image array 16, 18 and its co-operating focusing element array 13, 15, is configured to form an optically variable structure such as a moiré magnifier, a lenticular (interlaced) device or an integral imaging device, examples of which will be given below. The optical paths of the two resulting optical structures make use of the same thickness t of the transparent substrate (even if they do not direct overlap one another), which enables the device thickness to be kept small.

In addition to providing the basis of an optically variable effect when viewed in combination with the co-operating focusing element array, in this embodiment each image array is further configured to exhibit a static macroimage when viewed without the aid of its co-operating focusing element array. By “static macroimage” it is meant an image, such as an item of information, which is visible and intelligible to a human observer without any visual aid, e.g. without magnification and/or spatial filtering as may be performed by the focusing element arrays. Thus, in the FIG. 2 embodiment, when viewed from the front side (FV), the second image array 18 will appear as a static macroimage alongside the optically variable effect of the first image array 16, and when viewed from the rear side (RV), the first image array 16 will appear as a static macroimage alongside the optically variable effect of the second image array 18. It should be noted that it is not essential for both image arrays 16 and 18 to exhibit a macroimage when their static appearance is viewed: it may be the case that only image array 16 or image array 18 does so, and examples of such implementations will be given below with reference to FIGS. 25 and 26.

However, formation of both image arrays 16 and 18 with static macroimages is preferred and examples of this sort will therefore be described first.

A first example of an image array which can be used to form either the first image array 16 or the second image array 18, or both, is shown in FIG. 3. Here, the image array 16, 18, comprises a series of elongate image elements lying parallel to the x-axis, and forms a lenticular device in combination with a corresponding array of cylindrical lenses aligned along the x-axis and forming the co-operating focusing element array 13, 15 as described above.

The image array 16, 18 covers an area having the shape of a 5-pointed star symbol, bounded by periphery 29. In a first, outermost, star-shaped region 21 of the array, the coloured image elements 22 (shown in black) are arranged to sit in a first position under each lens of the co-operating array, e.g. positions (i) shown in FIG. 2. In a second, intermediate, star-shaped region 23, the coloured image elements 24 are arranged to sit in a second position under each lens of the co-operating array, e.g. positions (ii) shown in FIG. 2. In a third, central star-shaped region 25, the coloured image elements 26 are arranged to sit in a third position under each lens of the co-operating array, e.g. positions (iii) shown in FIG. 2. It will be appreciate that in fact registration between the lenses and image elements along the y-axis is not essential and each series of image elements corresponding to any one of the regions 21, 23 or 25 could take any of positions (i) (ii) or (iii) provided it remains the same in every set of image elements corresponding to one lens.

The appearance of the image array 16, 18 to the naked eye (i.e. its static macroimage 30) is shown in FIG. 4. The image elements 22, 24, 26 making up each region of the array are too small to be individually discerned and so the array appears as a region of substantially uniform colour bounded by star-shaped periphery 29. Since the proportion of coloured image elements to transparent spaces is substantially the same in each of the regions 21, 23, 25, there is substantially no contrast visible between them.

FIGS. 5(a), (b) and (c) show the varying appearance of the image array when it is viewed via its co-operating focusing element array, at three different viewing angles. At a first viewing angle, the lenses in the focusing element array will direct light from each of the image elements located at position (iii) under each lens to the viewer (see FIG. 2). The selected image elements thus combined to exhibit only the central star-shaped region 25 as shown in FIG. 5(a). After tilting though a certain angle, the lenses will now direct light from the elements at positions (ii) to the viewer, giving rise to an image of the intermediate star shaped region 23 only, as shown in FIG. 5(b). Upon continued tilting, the displayed image will switch again, since the lenses now select the image elements at positions (i) for direction to the viewer, such that only the outermost star-shaped region is displayed as shown in FIG. 5(c). As the device is tilted back and forth in this way, the appearance of the image array therefore appear animated, starting with a small star symbol (FIG. 5(a)) which expands when the device is tilted in one direction (FIGS. 5(b),(c)) and then contracts when tilted in the opposite direction. This relationship between the different images in denoted in the Figures by the arrow T, representing tilting. In this case, since the lenses and image elements are aligned along the x-axis, this optically variable effect will only be seen when the device is tilted about the x-axis. When the device is tilted about the y-axis, one of the views shown in FIGS. 5(a), (b) or (c) will be displayed, but it will remain static.

FIG. 6 shows the appearance of the device 10 as a whole, from various different viewing positions. In this example, both the image arrays 16, 18 have the same form as discussed with reference to FIGS. 3, 4 and 5, and both the focusing element arrays 13, 15 comprise cylindrical lenses aligned along the x-axis. FIGS. 6(a), (b) and (c) show the front view (FV) of the device from three different viewing angles. The first image array 16 exhibits the optically variable effect already described with respect to FIG. 5, with the star-shaped symbol appearing to expand and then contract upon tilting about the x-axis. Meanwhile, the second image array 18 appears as a static macroimage 30 having the form of a star shaped symbol of uniform colour. (The internal boundaries between the various regions of the array are shown in FIG. 6 for clarity but need not be visible in practice).

FIGS. 6(d), (e) and (f) show the rear view (RV) of the device 10 from three different viewing angles. Now, the second image array 18 exhibits the optically variable effect as already described with respect to FIG. 5 with the star-shaped symbol appearing to expand and then contract upon tilting about the x-axis, whilst the first image array 16 remains optically invariable and displays its static macroimage 30.

This results in a device with strong visual impact since from both sides, part of the device appears static whilst another part exhibits an optically variable effect. The two parts of the device can be directly compared against one another and the effect is easily describable.

In addition, the structure of the device lends itself well to multi-coloured implementations, since no registration is required between the first image element array and the second. Preferably, the first image array 16 is formed in a first colour, e.g. red, and the second image array 18 is formed in a second different colour, e.g. blue. This applies to all embodiments.

Additional benefits can be achieved by forming one or both of the image arrays 16, 18 in an iridescent or colour-shifting material such as an ink containing mica particles or flakes of thin-film interference layer stacks. Such materials are well known and suitable examples include Irodine™ as well as those disclosed in EP-A-1478520. This not only imparts an additional effect to the optically active appearance of each image array (i.e. when viewed in combination with the focussing elements), but also renders the static macroimages optically variable in the sense that their colour changes at different angles of view (although they remain static in that their size, shape and position does not change). This preference applies to all embodiments.

FIG. 7 shows a second example of an image array 16, 18 which can be used in the FIG. 2 device to produce a similar effect as that discussed with reference to FIG. 6. The image array is substantially the same as shown in FIG. 3, except that the image elements forming each region 21, 23, 25 of the array are fully interlaced with one another. Thus, the coloured elements 22 defining the outermost star region 21 continue through the intermediate and central star regions 23, 25, and the coloured elements 24 defining the intermediate region 23 continue through the central region 25. FIG. 8 shows the corresponding static macroimage 30 and it will be seen that once again this takes the form of an apparently solid star-shaped symbol with periphery 29. However, due to the continuation of the coloured image elements through the central regions of the array, the different regions 21, 23, 25 present different apparent optical densities and hence result in a halftone image in which there is a contrast visible between the three regions of the device, with the central region 25 appearing darkest and the outermost region 21 appearing lightest.

FIGS. 9(a), (b) and (c) show the optically variable appearance of the image array shown in FIG. 7 when viewed with a co-operating focusing element array and again this takes the form of an expanding and contracting star shape. However, in this case, the expanding star remains solid, since the central region 25 is visible at all angles of view and the intermediate region 23 remains visible when the outermost region 21 is displayed. However it will be noted that there is no contrast or halftone effect visible in the optically variable image—this is because despite the increased optical density of centre region 25 in the image array, only the portions of that region corresponding to elements 26 in the version shown in FIG. 3 will be displayed to the viewer, with the result that the apparent optical density is unchanged relative to the FIG. 3 version.

The use of image arrays giving rise to static macroimages which are symmetrical about at least one axis (such as the star shaped symbol used above) is preferred since those aspects of the macroimage which are retained when the device is viewed from the reverse (such as its periphery) maintain the same appearance. Similarly, it can be beneficial to utilise two image arrays with the same static macroimages to enhance continuity between the front and rear views. However, neither of these options are essential.

FIG. 10 shows a third example of first and second image arrays 16, 18, which could be used in a device such as that shown in FIG. 2. In FIG. 10, the static macroimage 30, 31 of each image array as viewed from the front side of the device is shown, although it will be appreciated that only one or the other will be visible from the front side in practice. Again, in this example the image arrays are configured to form lenticular devices with their co-operating focusing element arrays, which could again comprise cylindrical lenses. The first image array 16 denotes the number “5” and is made up of four images 41, 42, 43 and 44, each of which will be conveyed by a corresponding set of image elements interleaved with one another in a known manner. The different colours of the four images is only for clarity and in practice these will usually be the same as one another. The first image 41 is of the number “5” in a solid, thin line width. The second image 42 is a hollow outline of the number “5”, surrounding the first image 41. The third and fourth images 43, 44 are still larger outlines of the number “5”, Similarly, the second image array 18 denotes the number “0” (zero) and is made up of four images 45, 46, 47 and 48 which comprise a central, solid version of the number “0” (image 45) and three expanding outlines versions thereof (images 46, 47, 48).

FIG. 11 depicts the security device at various different viewing positions. FIGS. 11(a), (b), (c) and (d) show the front view (FV) of the security device at four different angles of view. The first image array 16 appears optically variable, exhibiting images 41, 42, 43 and 44 sequentially one after the other as tilting progresses. This gives the appearance of an expanding digit “5”. Meanwhile, the second image array 18 exhibits its static macroimage 31 which does not change upon tilting. FIGS. 11(e), (f), (g) and (h) show the rear view (RV) of the same device at four different angles of view. It will be noted that the direction of the digit “5” formed by the first image array appears backward since the device is being viewed in reverse. Now, the first image array forming the digit “5” exhibits its static macroimage 30 which does not change on tiling. Meanwhile, the second image array 18 appears optically variable, exhibiting images 45, 46, 47 and 48 sequentially one after the other as tilting progresses. This gives the appearance of an expanding digit “0”. The use of two image arrays which define complementary items of information in this way (i.e. the two items of information combine to form another, here the number “50”) is preferred since it emphasises the integration between the two parts of the device.

If the image elements making up the image arrays and the lenses are aligned along the x-axis, the optically variable effects described in relation to FIG. 11 will be seen when the device is tilted about the x-axis whereas if the image elements and lenses are aligned along the y-axis, the effect will be seen when the device is tilted about the x-axis. It should also be noted that this operative tilt direction need not be the same for both image arrays 16 and 18. For example, the elements of image array 16 and lenses of focussing element array 13 could be aligned with the x-axis whilst the elements of image array 18 and lenses of focussing element array 15 could be aligned with the y-axis. In this case, the front view would only exhibit its optically variable effect when the device is tilted about the x-axis and the rear view would only exhibit its optically variable effect when the device is tilted about the y-axis.

Expanding and/or contracting animations (also known as “pumping” effects) such as those shown above are advantageous for use in embodiments of the present invention since they can readily be configured to form a clear and intelligible static macroimage, defined at least in part by the outermost periphery of the largest image making up the set of animation frames. However, other animation effects such as motion effects (particularly linear motion effects) are also well suited for this use.

FIG. 12 shows a fourth example of first and second image arrays 16, 18, which could be used in a device such as that shown in FIG. 2. In FIG. 12, the static macroimage 30, 31 of each image array as viewed from the front side of the device is shown, although it will be appreciated that only one or the other will be visible from the front side in practice. Again, in this example the image arrays are configured to form lenticular devices with their co-operating focusing element arrays, which could again comprise cylindrical lenses. Here, each image array 16, 18 denotes a series of three laterally offset hexagons: 51, 52 and 53 in image array 16, and 54, 55 and 56 in image array 18. Each hexagon is an image made up of a corresponding set of image elements, interleaved in a known manner. The static macroimage 30, 31 presented by each image array 16, 18 appears as a chain made up of the three hexagons.

FIG. 13 depicts the security device at various different viewing positions. FIGS. 13(a), (b) and (c) show the rear view (RV) of the security device at three different angles of view. The first image array 16 appears optically invariable, exhibiting its static macroimage 30 at all tilt angles. Meanwhile, the second image array 18 exhibit images 56, 55 and 54 sequentially one after the other as tilting progresses. This gives the appearance of the hexagon symbol moving from left to right (in the −x axis direction) as the device is tilted. The apparent movement is emphasised by the contrast between the moving hexagon image and the adjacent static macroimage formed by image array 16. FIGS. 13(d), (e) and (f) show the front view (FV) of the same device at three different angles of view. Now, the first image array 16 exhibits its optically variable effect, with images 53, 52 and 51 appearing sequentially so as to give the impression of a hexagon moving from right to left (in the −x axis direction) as the device is tilted. The second image array 18, meanwhile, appears as static macroimage 31 which does not change upon tilting.

In the above examples, the first and second image arrays 16, 18 do not overlap one another, resulting in two items which appear distinct from one another in the final device. This provides the benefit that each image array 16, 18 can be designed largely independently of the other since the configuration of one will not impact upon viewing of the other. However, in other preferred implementations, the visual integration of the device is enhanced by arranging the two image arrays to overlap one another.

FIG. 14 shows in cross section a second embodiment of a security device 10 in which the first and second image arrays 16, 18 overlap one another. All other features of the security device 10 are the same as discussed in relation to FIG. 2 and so their description will not be repeated here. It will be appreciated that whilst in this example the first and second image arrays 16, 18 are depicted as wholly overlapping one another, this is not essential and the area of overlap need only be partial. Where the image arrays overlap one another it is necessary to ensure that neither completely obscures visualisation of the other, i.e. both are semi-transparent. This can be achieved either through careful design of the image arrays, so that each retains a large proportion of transparent surface area, and/or by forming each “coloured” image element of a semi-transparent material, e.g. ink which is not 100% opaque.

FIG. 15 shows an example of first and second image arrays 16, 18, which could be used in a device such as that shown in FIG. 14. The first image array 16 is shown in dotted lines and the second image array 18 is shown in solid lines (although in practice, typically both will appear solid). In FIG. 15, the static macroimage of each image array as viewed from the front side of the device is shown, although it will be appreciated that only one or the other will be visible from the front side in practice. Again, in this example the image arrays are configured to form lenticular devices with their co-operating focusing element arrays, which could again comprise cylindrical lenses.

The first image array 16 (dotted lines) is made up of four interlaced images 16a, 16b, 16c and 16d, each of which depicts an elliptical outline. The four ellipses are rotated relative to one another about a common central point giving the impression when all are viewed together of an “atom” symbol. Similarly, the second image array 18 (solid lines) is made up of four interlaced images 18a, 18b, 18c and 18d, again each depicting an ellipse, the set of which is rotated by 22.5 degrees relative to those of the first image array 16. Preferably the first and second image arrays are formed in different colours but this is not essential.

FIG. 16 depicts the security device at various different viewing positions. FIGS. 16(a), (b), (c) and (d) show the front view (FV) of the security device at four different angles of view. The first image array 16 appears optically variable, exhibiting ellipses 16a, 16b, 16c and 16d sequentially one after the other as tilting progresses. This gives the animated appearance of a single, rotating elliptical ring. Meanwhile, the second image array 18 exhibits its static macroimage which does not change upon tilting, in which all four of its ellipses are simultaneously visible. The second image array 18 appears as a background to the animation effect of the first image array 16. FIGS. 11(e), (f), (g) and (h) show the rear view (RV) of the same device at four different angles of view. Now, the second image array 18 appears optically variable, exhibiting ellipses 18a, 18b, 18c and 18d sequentially one after the other as tilting progresses, giving the animated appearance of a single, rotating elliptical ring against a static background provided by the four ellipses making up first image array 16. It is also possible to pattern the lenses on one or both sides such that the lenses are not operative in certain regions of FIG. 16 in these regions the full static image will be observed as a result of the combination of the two static macroimages. This patterning can be achieved by locally omitting the lenses or by applying a resin or coating on top of the lenses with a similar refractive index to the lenses. This option of patterning the lenses applies to all embodiments.

Many other lenticular effects could be implemented by appropriate design of the image arrays 16, 18 and focusing element arrays 13, 15. For instance, whilst in some cases it may be desirable to register one or both of the focusing element arrays to the respective co-operating image array, so that a particular pre-determined image is displayed at each viewing position, this is not essential. Examples of lenticular effects which are particularly suited for use in cases where the focusing element arrays are not registered to the image elements are disclosed in WO-A-2013/153196 and WO-A-2011/051668, both of which are incorporated by reference in their entirety. Further, the examples set out above have been described as one-dimensional lenticular devices, i.e. operating in one tilt direction only. However, the same effects could be achieved as two-dimensional lenticular devices, utilising spherical or aspherical lenses in a two-dimensional array and a corresponding two-dimensional array of interleaved image elements or pixels. Examples of two-dimensional lenticular devices are disclosed in British patent application number 1313362.4, which is hereby incorporated by reference in its entirety.

The two image arrays can also generate their respective optically variable effects based on different mechanisms from one another, e.g. the first image array 16 could comprise elongate image elements and form a one-dimensional lenticular device in combination with a first focusing element array comprising cylindrical lenses, whilst the second image array 18 could comprise a two-dimensional array of image elements or pixels and form a two-dimensional lenticular device in combination with a second focusing element array comprising spherical or aspherical lenses.

Whilst in all the above examples, the optically variable effects have been generated based on the lenticular (interlacing) mechanism, this is not essential and the invention is equally applicable to other optically variable effect generating mechanisms, such as moiré magnification and integral imaging.

FIG. 17 shows a third embodiment of a security device 10, in cross-section. The construction is substantially the same as that described with respect to FIG. 2 above and so will not be described again in detail, except for those respects which differ from previous embodiments. Again, the first and second image arrays 16, 18 are located in image planes such that each co-operates with either the first or second focusing element array, this time to give rise to a moiré magnification effect. The effect could be one-dimensional, in which case the focusing element arrays may comprise cylindrical lenses, but is preferably two-dimensional, which each focussing element array comprising a two-dimensional array of spherical or aspherical lenses. Each image array 16, 18 comprises a corresponding array of microimages (rather than image elements). Within each image array, all the microimages are substantially identical to one another and each depicts an item of information such as a letter, number, symbol, line or dot. The microimages are arranged on a regular grid with similar or identical periodicity to that of the co-operating focusing element array. In some examples, the pitch of the microimage array is slightly mis-matched relative to that of the co-operating focusing element array, in order to give rise to a moiré effect. Additionally or alternatively, the microimage array may be rotated relative to the focussing element array in order to give rise to the effect. Full details as to how to achieve a moiré effect can be found in WO-A-2011/107782, hereby incorporated by reference in its entirety. The result will be a magnified version of the microimage array, which appears to move relative to the substrate when the device is tilted. The image plane on which the magnified version is perceived may appear to be located above or below the plane of the substrate itself, and can be configured to appear curved or tilted if desired (see WO-A-2011/107782). The moiré effects exhibited by the two image arrays 16, 18 could be the same as one another or could differ in terms of any of: the microimage content (i.e. different information items), the magnification level, the apparent position of the image plane and any curvature or tiling of that plane. As before, the two image arrays are preferably provided in different colours to one another.

FIG. 18 shows a front view of the security device of FIG. 17 with exemplary image arrays 16, 18. For clarity, the size of the lenses making up array 13 (shown as dashed-line circles) and of the microimages making up each of the image arrays 16, 18, has been greatly exaggerated in this Figure. In addition the optical effect of the lenses has not been illustrated, with the result that both image arrays appear to exhibit the same effect as one another. This is not the case in practice as will be explained below.

The first image array 16 takes the form of a regular 2D array of microimages each of which denotes the “£” (pound) symbol. The array is provided over an area bounded by periphery 35, which also has the shape of a “£” (pound) symbol. The periphery 35 itself may or may not be marked by a visible line (as shown). The second image array 18 comprises a regular 2D array of microimages each of which denotes the digit “5”. The array is provided over an area bounded by periphery 36, which also has the shape of the digit “5”. Again, the periphery 36 itself may or may not be marked.

FIGS. 19(a) and (b) show the appearance of the device depicted in FIG. 18 from the front and rear sides respectively, taking into account the realistic size of the microimages and the effect of the lenses. When viewed from the front side, as shown in FIG. 19(a), the first image array 16 acts in co-operation with the first focusing element array 13 to exhibit a moiré magnification effect whereby a magnified version of the microimages forming the first image array 16 is visible. This appears as an array of “£” symbols visible across an area which also forms the shape of a “£” symbol, demarcated by periphery 35 which may or may not be visible. The magnified array may appear to “float” or be recessed behind the surface of the device, and to move upon tilting. Meanwhile, the second image array 18 is optically inactive and exhibits its static macroimage, which takes the form of an area of apparently uniform colour (formed by the microimage array, which is too small to be resolved by the naked eye) extending over an area having the shape of the digit “5”, bounded by periphery 36 (which again may or may not be marked).

When viewed from the rear side, as shown in FIG. 19(b), the effects are reversed. Now, the first image array 16 exhibits its static macroimage, which appears as a uniformly-coloured “£” symbol, bounded by periphery 35. The second image array 18 now generates a moiré magnification effect in co-operation with focusing element array 15, resulting in a magnified array of digits “5” across an area also forming the shape of the digit “5”, but reversed. In this example, the moiré magnified digits “5” have also been depicted as appearing reversed but in practice it may be preferred to form the relevant microimages the other way round, so that these “5”'s appear correctly orientated.

It will be appreciated that in this example, as mentioned in relation to FIG. 2, since the two image arrays do not overlap, it is not essential to provide each of the focussing element arrays across the whole of the device. Each need only be provided in the name region as that in which its co-operating image array is located.

A further example of an image array 16 in the form of a microimage array is shown in FIGS. 20 and 21. FIG. 20 shows a portion 10″ of the security device 10 shown in FIG. 17, including image array 16, from the rear view (RV). Since the image array 16 is being viewed without the aid of co-operating focussing elements, it appears static and in this example displays a static macroimage in the form of a halftone image 37 which in this case is a portrait. The macroimage is formed of a regular array of microimages 16a, 16b making up image array 16. In this example, each microimage is of the letter “A”. Relatively dark areas of the macroimage are displayed by arranging the microimages to have a greater line width (stem width) in that area, as illustrated by enlarged region (i) where the microimages 16a are shown to be of thick line width. Relatively light areas of the macroimage are displayed by the use of microimages with a thinner line width in that area, as illustrated by enlarged region (ii) where the microimages 16b are shown to be of thinner line width. Thus the line width of the microimages varies across the array 16 in accordance with the macroimage 37 which is to be displayed. In other cases, similar end results could be achieved by varying the size, number and/or frequency of the microimages across the array 16, instead of or in addition to varying the line width.

FIG. 21 shows the same device portion 10″ when viewed from the other side (FV) of the device, i.e. with the aid of the co-operating focusing element array. Now, the same image array 16 appears optically active, the microimages being synthetically magnified by the moiré effect such that a magnified array 38 of the microimages is exhibited. Since the moiré magnification mechanism inherently involves sampling from multiple microimages, the variation in line width, size, number and/or frequency across the microimage array is smoothed out to an extent and they magnified images may all appear the same, or varying only more slowly across the device. The images may also appear rotated relative to the orientation of the microimage array itself.

More details as to how an image element array can be configured to exhibit a static macroimage, and further examples of the same which can be utilized in the presently disclosed devices, can be found in WO-A-2013/056299. The same principles can be applied to microimage arrays forming part of integral imaging devices and/or to image elements used in lenticular devices.

FIG. 22 shows a fourth embodiment of a security device 10 in cross section. The construction of the device is the same as that described above with reference to FIG. 17, except that here the first and second image arrays 16, 18 are arranged to overlap. As discussed with reference to the lenticular embodiments, again it is necessary to ensure in such cases that neither image array entirely obscures visualisation of the other. However, microimage arrays as used in moiré magnifiers are well suited to this since typically the array consists of a grid of coloured microimages against a transparent background (or vice versa). In this case, the first image array 16 is arranged to extend across a wider area than that of the second image array 18.

FIGS. 23(a) and (b) show the appearance of the security device of FIG. 22, from the rear and front sides respectively. From the rear side (FIG. 23(a)), the moiré effect generated by the second image array 18 is visible, whilst the first image array 16 exhibits its static macroimage 30. Thus, the second image array 18 appears as a magnified array of its microimages, which here denote the letter “A”. The magnified image appears against a static image formed by first image array 16, here a circle of an apparently uniform first colour (preferably different from that of the magnified image which appears in a second colour), which extends beyond the boundary of the magnified image array. From the front side, the first image array 16 appears as a magnified array of the letter “B”, generated by moiré magnification, in the first colour. Within the magnified image, the static macroimage 31 of the second image array 18 is now visible as a circle of the second colour.

Whilst in all of the above examples the transparent substrate 11 has been depicted as monolithic, this is not essential and the transparent substrate could be multi-layered. This may be desirable in particular where the two focusing element arrays are required to have different focal lengths, e.g. to achieve different levels of magnification. FIG. 24 shows a cross-section of a fifth embodiment of a security device 10 in which this is the case. Here the transparent substrate 11 is made up of two layers 12a, 12b which are laminated together by heat and/or adhesive (not shown). The layer 12a may for example be a backing layer on which the first focusing array 13 has first been formed. Either or both layers 12a, 12b may contain a visible or non-visible additive such as a coloured tint or fluorescent material if desired. The first image array 16 is located as before on the second surface 11b of the transparent substrate. However the second image array 18 is located at the interface between layers 12a and 12b, having been formed on or in the surface of either one of those layers. The focal lengths f₁, f₂ of the two focusing element arrays 13, 15 are different from one another, with f₁ being substantially equal to the thickness t of the whole substrate, whilst f₂ is smaller and substantially equal to the thickness of layer 12b.

It will also be appreciated that whilst in previous examples, both image arrays 16 and 18 generated optically variable effects based on the same mechanism as one another, e.g. lenticular or moiré magnification, this is not essential since each could operate on a different mechanism. For example, in the FIG. 24 embodiment, the first image array 16 is arranged to generate a two-dimensional moiré magnification (or integral imaging) effect in co-operation with focusing element array 13 which here comprises a 2D array of spherical or aspherical lenses. The second image array 18 meanwhile is configured to generate a one-dimensional lenticular effect in co-operation with focussing element array 15, which here comprises an array of parallel, elongate cylindrical lenses.

In the above examples, both the first and second image arrays 16,18 have been configured to exhibit static macroimages when viewed without the benefit of the co-operating focussing element array. However this is not essential provided one or the other image array does so. FIG. 25 provides an example in which only the second image array 18 exhibits a static macroimage whilst the first does not (although of course this could be reversed). FIG. 25(a) shows the device in cross section and it will be seen that the construction of the device 10 or 10′ is substantially the same as shown in FIG. 2. As such, a detailed description will be omitted here and reference is made to the description above where like reference signs are used for like components. In this case, the transparent substrate 11 is shown extending either side of the security device region and opacifying layers 60, 61 (e.g. print/coating layers or paper) are shown to surround the device on both sides. This is not essential and in other cases the same function could be performed by a document substrate to which or into which the device region 10 alone is applied. The first image array 16 is provided in an annular region 62 of the device and the section image array is provided in a circular region 63 at the centre of annular region 62. In this case there is no overlap between the two image arrays although this is equally possible.

The device is shown in plan view in FIG. 25(b) from the front (FV), and in FIG. 25(c) from the rear (RV). From the front, the annular region 62 in which first image array 16 is located appears optically variable and in this case the image array 16 and co-operating focusing element array 13 are configured to exhibit a lenticular effect of a chevron which appears to move around the annular region 62 as the device is tilted. This is achieved by interlacing images showing the chevron at different locations around the region. Only eight of those regions are shown but in practice there may be many more, preferably resulting in a smooth animated appearance. In the centre region 63, the static macroimage formed by image array 18 is visible. In this case, this comprises a star shape formed of four straight lines intersecting one another at their midpoints. This remains stationary upon tilting.

When the device is viewed from the rear (FIG. 25(c)), the second image array 18 in the centre region 63 now exhibits its optically variable effect in conjunction with focussing array 15, which in this case is again a lenticular effect. In a similar manner to the FIG. 16 example, here each of the four intersecting lines is visible one at a time as the device is tilted, giving rise to the appearance of rotation. The outer annular region 62, meanwhile, appears static and featureless since the first image array 16 has not been configured to display a macroimage. Thus, the region 62 may appear to carry a tint or colour as a result of the image array 16 but will not itself convey recognisable information to the viewer.

A variant of the FIG. 25 device is shown in FIG. 26. Here, the structure of the device 10 is exactly the same as in FIG. 25, but the lower opacifying layer 61 is continued across annular region 62 such that this region constitutes a “half-window”. Now, when viewed from the front side (FIG. 26(b)), the optically variable lenticular effect of image array 16 is viewed against a background formed by layer 61. When viewed from the rear (FIG. 26(c)), only the centremost region 63 is visible, the outline of annular region 62 being shown here in dashed lines only for reference.

The minimum thickness t of the device 10 is directly related to focal lengths of the focussing element arrays 13, 15 and hence to the size of the focusing elements themselves. As such, the optical geometry must be taken into account when selecting the thickness of the transparent layer 11. In preferred examples the device thickness t is in the range 5 to 200 microns. “Thick” devices at the upper end of this range are suitable for incorporation into documents such as identification cards and drivers licenses, as well as into labels and similar. For documents such as banknotes, thinner devices are desired. At the lower end of the range, the limit is set by diffraction effects that arise as the focusing element diameter reduces: e.g. lenses of less than 10 micron base diameter/width (hence focal length approximately 10 microns) and more especially less than 5 microns (focal length approximately 5 microns) will tend to suffer from such effects. Therefore the limiting thickness t of such structures is believed to lie between about 5 and 10 microns.

The lens arrays 13, 15 can be made using cast cure or embossing processes, or could be printed using suitable transparent substances. The periodicity and therefore maximum base diameter or width of the lenticular focusing elements is preferably in the range 5 to 200 μm, more preferably 10 to 60 μm and even more preferably 20 to 40 μm. The f number for the lenticular focusing elements is preferably in the range 0.1 to 16 and more preferably 0.5 to 4.

In all of the above embodiments, the image arrays 16, 18 could be formed in various different ways. For example, the image arrays could be formed of ink, for example printed onto the substrate 11 or onto another layer which is then positioned adjacent to the substrate 11 or forms part of the substrate 11 as discussed in relation to FIG. 24. The inks used could be conventional, single colour inks, or could be iridescent or colour-shifting inks as mentioned above. However, in other examples the image arrays can be formed by relief structures and a variety of different relief structures suitable for this are shown in FIG. 27. Thus, FIG. 27a illustrates image regions (“coloured” portions) of the image arrays (IM), in the form of embossed or recessed regions while the non-embossed portions correspond to the non-imaged (transparent) regions of the arrays (NI). FIG. 27b illustrates image regions of the arrays in the form of debossed lines or bumps.

In another approach, the relief structures can be in the form of diffraction gratings (FIG. 27c) or moth eye/fine pitch gratings (FIG. 27d). Where the image arrays are formed by diffraction gratings, then different image portions of an image array can be formed by gratings with different characteristics. The difference may be in the pitch of the grating or rotation. This can be used to achieve a multi-colour diffractive image which will also exhibit an optically variable effect such as lenticular animation or moiré magnification through the mechanisms described above. For example, if the image array comprises image elements which had been created by writing different diffraction tracks for each element, then as the device is tilted, lenticular transition from one image to another will occur as described above, during which the colour of the images will progressively change due to the different diffraction gratings. A preferred method for writing such a grating would be to use electron beam writing techniques or dot matrix techniques.

Such diffraction gratings for moth eye/fine pitch gratings can also be located on recesses or bumps such as those of FIGS. 27a and b, as shown in FIGS. 27e and f respectively.

FIG. 27g illustrates the use of a simple scattering structure providing an achromatic effect.

Further, in some cases the recesses of FIG. 27a could be provided with an ink or the debossed regions or bumps in FIG. 27b could be provided with an ink. The latter is shown in FIG. 27h where ink layers 100 are provided on bumps 110. Thus the image areas of each image element could be created by forming appropriate raised regions or bumps in a resin layer provided on transparent substrate 11 shown in FIG. 2. This could be achieved for example by cast curing or embossing. A coloured ink is then transferred onto the raised regions typically using a lithographic, flexographic or gravure process. In some examples, some image elements could be printed with one colour and other image elements could be printed with a second colour. In this manner when the device is tilted to create the optically variable effects described above, the images will also be seen to change colour as the observer moves from one viewing position to another. In another example all of the image elements in one region of the device could be provided in one colour and then all in a different colour in another region of the device.

Finally, FIG. 27i illustrates the use of an Aztec structure.

Additionally, image and non-image areas could be defined by combination of different element types, e.g. the image areas could be formed from moth eye structures whilst the non-image areas could be formed from gratings. Alternatively, the image and non-image areas could even be formed by gratings of different pitch or orientation.

Where the image elements are formed solely of grating or moth-eye type structures, the relief depth will typically be in the range 0.05 microns to 0.5 microns. For structures such as those shown in FIGS. 27 a, b, e, f, h and i, the height or depth of the bumps/recesses is preferably in the range 0.5 to 10 μm and more preferably in the range of 1 to 2 μm. The typical width of the bumps or recesses will be defined by the nature of the artwork but will typically be less than 100 μm, more preferably less than 50 μm and even more preferably less than 25 μm. The size of the image elements and therefore the size of the bumps or recesses will be dependent on factors including the type of optical effect required, the size of the focusing elements and the desired device thickness. For example if the width or diameter of the focusing elements is 30 μm then each image element may be around 15 μm wide or less in a lenticular device, and even smaller in a moiré magnifier. Alternatively for a smooth lenticular animation effect it is preferable to have as many views as possible, typically at least five but ideally as many as thirty. In this case the size of the image elements (and associated bumps or recesses) should be in the range 0.1 to 6 μm. In theory, there is no limit as to the number of image elements which can be included but in practice as the number increases, the resolution of the displayed images will decrease, since an ever decreasing proportion of the devices surface area is available for the display of each image.

This is also where using a diffractive structure to provide the image elements provides a major resolution advantage: although ink-based printing is generally preferred for reflective contrast and light source invariance, techniques such as modern e-beam lithography can be used generate to originate diffractive image strips down to widths of 1 μm or less and such ultra-high resolution structures can be efficiently replicated using UV cast cure techniques.

In still further examples one or both of the image arrays could be formed by demetallising a metal layer in accordance with the desired pattern. A particularly preferred method for forming a high resolution image array suitable for use in the presently disclosed devices is described in our British patent application no. 1510073.8. This involves exposing a resist layer on a metallised substrate to radiation which changes the solubility of the resist through a patterned mask which is carried, for example, on the surface of a cylinder. The exposure of the resist can therefore take place in a web-based process. After exposure, the substrate carrying the patterned resist is immersed in etchant leading to the selective dissolution of the metal layer in accordance with the desired pattern to form an image array. This has been found to achieve particularly high resolution.

The two image arrays could be formed using different ones of the described methods. For example one of the image arrays could be formed by demetallisation whilst the other could be printed or comprise a relief structure.

Security devices of the sorts described above can be incorporated into or applied to any product for which an authenticity check is desirable. In particular, such devices may be applied to or incorporated into documents of value such as banknotes, passports, driving licenses, cheques, identification cards etc. The security device can either be formed directly on the security document or may be supplied as part of a security article, such as a security thread or patch, which can then be applied to or incorporated into such a document.

Such security articles can be arranged either wholly on the surface of the base substrate of the security document, as in the case of a stripe or patch, or can be visible only partly on the surface of the document substrate, e.g. in the form of a windowed security thread. Security threads are now present in many of the world's currencies as well as vouchers, passports, travelers' cheques and other documents. In many cases the thread is provided in a partially embedded or windowed fashion where the thread appears to weave in and out of the paper and is visible in windows in one or both surfaces of the base substrate. One method for producing paper with so-called windowed threads can be found in EP-A-0059056. EP-A-0860298 and WO-A-03095188 describe different approaches for the embedding of wider partially exposed threads into a paper substrate. Wide threads, typically having a width of 2 to 6 mm, are particularly useful as the additional exposed thread surface area allows for better use of optically variable devices, such as that presently disclosed.

The security article may be incorporated into a paper or polymer base substrate so that it is viewable from both sides of the finished security substrate at at least one window of the document. Methods of incorporating security elements in such a manner are described in EP-A-1141480 and WO-A-03054297. In the method described in EP-A-1141480, one side of the security element is wholly exposed at one surface of the substrate in which it is partially embedded, and partially exposed in windows at the other surface of the substrate.

Base substrates suitable for making security substrates for security documents may be formed from any conventional materials, including paper and polymer. Techniques are known in the art for forming substantially transparent regions in each of these types of substrate. For example, WO-A-8300659 describes a polymer banknote formed from a transparent substrate comprising an opacifying coating on both sides of the substrate. The opacifying coating is omitted in localised regions on both sides of the substrate to form a transparent region. In this case the transparent substrate can be an integral part of the security device or a separate security device can be applied to the transparent substrate of the document. WO-A-0039391 describes a method of making a transparent region in a paper substrate. Other methods for forming transparent regions in paper substrates are described in EP-A-723501, EP-A-724519, WO-A-03054297 and EP-A-1398174.

The security device may also be applied to one side of a paper substrate so that portions are located in an aperture formed in the paper substrate. An example of a method of producing such an aperture can be found in WO-A-03054297. An alternative method of incorporating a security element which is visible in apertures in one side of a paper substrate and wholly exposed on the other side of the paper substrate can be found in WO-A-2000/39391.

Examples of such documents of value and techniques for incorporating a security device will now be described with reference to FIGS. 28 to 31.

FIG. 28 depicts an exemplary document of value 200, here in the form of a banknote. FIG. 28a shows the banknote in plan view whilst FIGS. 28b and c show two cross-sections of the same banknote along the lines X-X′ and Y-Y′ respectively. In this case, the banknote is a polymer (or hybrid polymer/paper) banknote, having a transparent substrate 201. Two opacifying layers 202 and 203 are applied to either side of the transparent substrate 201, which may take the form of opacifying coatings such as white ink, or could be paper layers laminated to the substrate 201.

The opacifying layers 202 and 203 are omitted across selected regions 204, 205a and 205b, each of which forms a window within which a security device or part of a security device is located. In this case, a first complete security device 10′ is disposed within window 204. As shown best in the cross-section of FIG. 28b, first and second arrays of focusing elements 13, 15 is provided on both sides of the transparent substrate 201, and co-operating image arrays 16, 18 are provided on the opposite surfaces of the substrate as described in any of the embodiments above. When the document is viewed from the side of lens array 13 (the front view FV), the optically variable effect of array 16 can be viewed upon tilting the device whilst adjacent array 18 visible in the same window 204 exhibits its static macroimage. From the other side (rear view RV), the effects reverse as previously explained. A second security device 10 is also provided on banknote 200, but in this case part of the device is located in window 205a whilst another part is located in window 205b. As shown best in the cross-section of FIG. 28(c), the first focusing element array 13 is provided in window 205a opposite first image array 16, forming a first part 10a of the security device 10. The second focusing element array 15 is provided in window 205b, opposite second image array 18, forming a second part 10b of the security device 10. In combination, the two parts 10a and 10b form a complete device as described with reference to any of the embodiments detailed above. It should be noted that the two focusing element arrays 13, 15 and/or the two image arrays 16, 18 could each be provided in both windows if preferred.

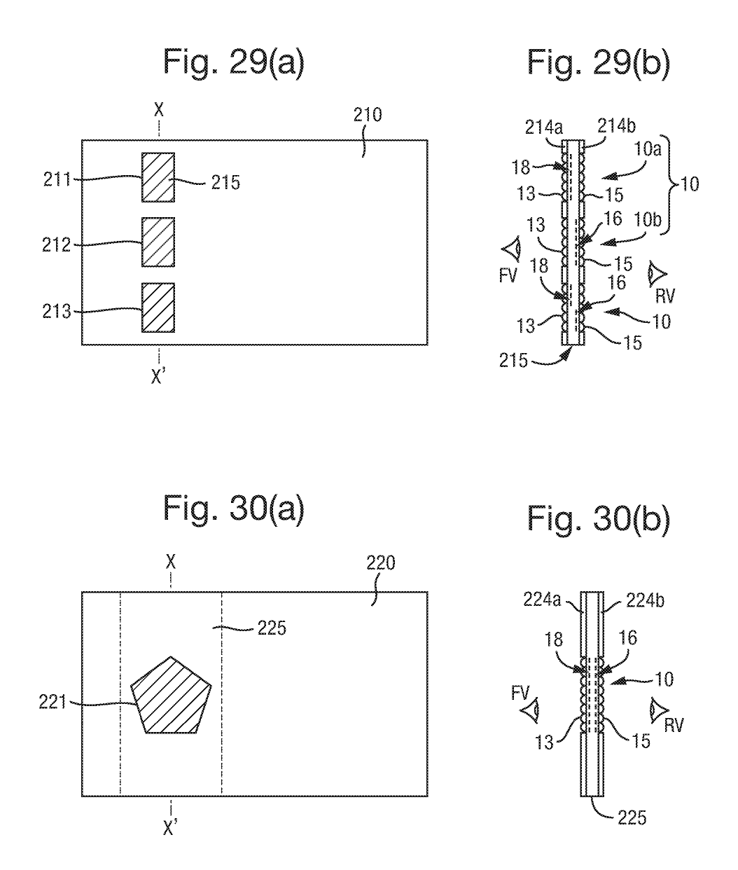

In FIG. 29 the banknote 210 is a conventional paper-based banknote provided with a security article 215 in the form of a security thread, which is inserted during paper-making such that it is partially embedded into the paper so that portions of the paper 214a and 214b lie on either side of the thread. This can be done using the techniques described in EP0059056 where paper is not formed in the window regions during the paper making process thus exposing the security thread 215 in window regions 211, 212 and 213 of the banknote. Alternatively the window regions 211, 212 and 213 may for example be formed by abrading the surface of the paper in these regions after insertion of the thread. The security device is formed on the thread 210, which comprises a transparent substrate with lens arrays 13, 15 provided on both sides and image arrays 16, 18 provided in selected locations. In this case, windows 211 and 212 each reveal parts 10a and 10b of a device 10, whereas a complete device 10 is contained within window 213. In the illustration, the lens arrays 13, 15 are depicted as being discontinuous between each exposed region of the thread, although in practice typically this will not be the case and the lens arrays (and optionally image arrays) will be formed continuously along the thread. Alternatively several security devices could be spaced from each other along the thread, as in the embodiment depicted, with different or identical images displayed by each.

In FIG. 30, the banknote 220 is again a conventional paper-based banknote, provided with a strip element or insert 225. The strip 225 is based on a transparent substrate and is inserted between two plies of paper 224a and 224b. The security device 10 is formed by first and second lens arrays 13, 15 on each side of the strip substrate 225, and co-operating image arrays 16, 18 which here overlap one other. The paper plies 224a and 224b are apertured across region 221 to reveal the security device 10, which in this case may be present across the whole of the strip 225 or could be localised within the aperture region 221.

A further embodiment is shown in FIG. 31 where FIGS. 31(a) and (b) show the front and rear sides of the document 230 respectively, and FIG. 31(c) is a cross section along line Z-Z′. Security article 235 is a strip or band comprising a security device 10 according to any of the embodiments described above. The security article 235 is formed into a security document 5230 comprising a fibrous substrate, using a method described in EP-A-1141480. The strip is incorporated into the security document such that it is fully exposed on one side of the document (FIG. 31(a)) and exposed in one or more windows 231 on the opposite side of the document (FIG. 31(b)). Again, the security device 10 is formed on the strip 235, which comprises a transparent substrate with first and second lens arrays formed on each surface and co-operating image arrays as previously described.

Alternatively a similar construction can be achieved by providing paper 230 with an aperture 231 and adhering the strip element 235 onto one side of the paper 230 across the aperture 231. The aperture may be formed during papermaking or after papermaking for example by die-cutting or laser cutting.

In general when applying a security article such as a strip or patch carrying the security device to a document, it is preferable to bond the article to the document substrate in such a manner which avoids contact between those lenses which are utilised in generating the desired optical effects and the adhesive, since such contact can render the lenses inoperative. For example, the adhesive could be applied to the lens array(s) as a pattern that the leaves an intended windowed zone of the lens array(s) uncoated, with the strip or patch then being applied in register (in the machine direction of the substrate) so the uncoated lens region registers with the substrate hole or window.

The security device of the current invention can be made machine readable by the introduction of detectable materials in any of the layers or by the introduction of separate machine-readable layers. Detectable materials that react to an external stimulus include but are not limited to fluorescent, phosphorescent, infrared absorbing, thermochromic, photochromic, magnetic, electrochromic, conductive and piezochromic materials.

Additional optically variable devices or materials can be included in the security device such as thin film interference elements, liquid crystal material and photonic crystal materials. Such materials may be in the form of filmic layers or as pigmented materials suitable for application by printing. If these materials are transparent they may be included in the same region of the device as the security feature of the current invention or alternatively and if they are opaque may be positioned in a separate laterally spaced region of the device.

The security device may comprise a metallic layer laterally spaced from the security feature of the current invention. The presence of a metallic layer can be used to conceal the presence of a machine readable dark magnetic layer. When a magnetic material is incorporated into the device the magnetic material can be applied in any design but common examples include the use of magnetic tramlines or the use of magnetic blocks to form a coded structure. Suitable magnetic materials include iron oxide pigments (Fe₂O₃ or Fe₃O₄), barium or strontium ferrites, iron, nickel, cobalt and alloys of these. In this context the term “alloy” includes materials such as Nickel:Cobalt, Iron:Aluminium:Nickel:Cobalt and the like. Flake Nickel materials can be used; in addition Iron flake materials are suitable. Typical nickel flakes have lateral dimensions in the range 5-50 microns and a thickness less than 2 microns. Typical iron flakes have lateral dimensions in the range 10-30 microns and a thickness less than 2 microns.

In an alternative machine-readable embodiment a transparent magnetic layer can be incorporated at any position within the device structure. Suitable transparent magnetic layers containing a distribution of particles of a magnetic material of a size and distributed in a concentration at which the magnetic layer remains transparent are described in WO03091953 and WO03091952.

Negative or positive indicia may be created in the metallic layer or any suitable opaque layer. One way to produce partially metallised/demetallised films in which no metal is present in controlled and clearly defined areas, is to selectively demetallise regions using a resist and etch technique such as is described in U.S. Pat. No. 4,652,015. Other techniques for achieving similar effects are for example aluminium can be vacuum deposited through a mask, or aluminium can be selectively removed from a composite strip of a plastic carrier and aluminium using an excimer laser. The metallic regions may be alternatively provided by printing a metal effect ink having a metallic appearance such as Metalstar® inks sold by Eckart.

1-43. (canceled)

44. A security device, comprising:
a transparent substrate having opposing first and second surfaces;
a first focusing element array disposed on the first surface of the transparent substrate;
a second focusing element array disposed on the second surface of the transparent substrate;
a first image array disposed on or in the transparent substrate in a first image array plane and configured to co-operate with the first focusing element array to exhibit an optically variable effect when viewed from a first side of the security device; and
a second image array disposed on or in the transparent substrate in a second image array plane, different from the first image array plane, the second image array being configured to co-operate with the second focusing element array to exhibit an optically variable effect when viewed from a second side of the security device;
wherein at least the first image array is further configured to exhibit a first static macroimage when viewed from the second side of the device.

45. A security device according to claim 44, wherein the second image array is further configured to exhibit a second static macroimage when viewed from the first side of the device.

46. A security device according to claim 44, wherein the first image array plane is located inside the focal range of the first focussing element array and outside the focal range of the second focussing element array, and the second image array plane is located inside the focal range of the second focussing element array and outside the focal range of the first focussing element array.

47. A security device according to claim 44, wherein the first image array plane is located closer to the second focusing element array than to the first focusing element array, and the second image array plane is located closer to the first focusing element array than to the second focusing element array.

48. A security device according to claim 44, wherein the first image array plane is the second surface of the substrate, and the second image array plane is the first surface of the substrate.

49. A security device according to claim 44, wherein the focal length of the first focusing element array is substantially equal to the focal length of the second focusing element array.

50. A security device according to claim 44, wherein the focal length of the first focusing element array and/or of the second focusing element array is greater than half the thickness of the transparent substrate.

51. A security device according to claim 44, wherein the first and second focusing element arrays overlap one another at least partially.

52. A security device according to claim 44, wherein the first image array is laterally offset from the second image array such that the first and second image arrays do not overlap one another, or only partially overlap one another.

53. A security device according to claim 44, wherein the first and second image element arrays overlap one another at least partially.

54. A security device according to claim 44, wherein the first and/or second static macroimage exhibits at least one item of information defined at least in part by one of: the periphery of the respective first and/or second image array; and
a halftone image carried by variations across the respective first and/or second image array.

55. A security device according to claim 44, wherein the first and/or second static macroimage is symmetrical about at least one axis.

56. A security device according to claim 44, wherein the first and/or second static macroimage exhibits at least one item of information comprising any of: alphanumeric text, a letter or number, a symbol, a portrait, a logo or another graphic.

57. A security device according to claim 44, wherein the first and second image arrays are of different colours from one another.

58. A security device according to claim 44, wherein the first and/or second image array comprises one of:
an array of image elements configured such that each focusing element within the co-operating focusing element array can direct light from any one of a respective set of at least two image elements to the viewer, in dependence on the viewing angle, each image element within each set exhibiting a portion of a corresponding image whereby, depending on the viewing angle, the array of focusing elements directs light from selected image elements to the viewer, such that as the device is tilted different ones of the respective images are displayed sequentially by the selected image elements of each set in combination;
an array of substantially identical microimages, and the pitches of the focusing elements in the co-operating focusing element array and of the array of microimage elements and their relative orientations are such that the array of focusing elements co-operates with the array of microimage elements to generate a magnified version of the microimage elements due to the moiré effect; and
an array of microimages each depicting the same object from a different viewpoint, and the pitches and orientation of the focusing elements in the co-operating focusing element array and of the array of microimage elements are the same, such that the array of focusing elements co-operates with the array of microimage elements to generate a magnified, optically-variable version of the object.

59. A security device according to claim 58, wherein the size and/or optical density of the image elements or microimages in the first and/or second image array varies across the array to form a halftone static macroimage.

60. A security device according to claim 44, wherein the optically variable effects exhibited by the first and/or second image arrays in combination with the co-operating focusing element arrays are exhibited upon tilting the device in at least one direction.

61. A security device according to claim 44, wherein the first and/or second focusing element array is registered to the co-operating image array.

62. A security device according to claim 44, wherein the first and/or second image array is defined by inks or is defined by a relief structure.

63. A security article comprising a security device according to claim 44, wherein the security article is a security thread, strip, foil, insert, transfer element, label or patch.

64. A security document comprising a security device according to claim 44, wherein the security document is a banknote, cheque, passport, identity card, driver's license, certificate of authenticity, fiscal stamp or other document for securing value or personal identity.

65. A security document according to claim 64, comprising a transparent document substrate which forms the transparent substrate and at least one opacifying layer disposed on the transparent document substrate so as to define one or more transparent windows within which the first and second image arrays are visible from both sides of the document.

66. A security document according to claim 64, comprising a security article comprising the security device, wherein the security article is a security thread, strip, foil, insert, transfer element, label or patch applied to or incorporated into a document substrate, the document substrate having one or more transparent windows therethrough within which the first and second image arrays are visible from both sides of the document.

67. A method of manufacturing a security device, comprising:
providing a transparent substrate having opposing first and second surfaces;
forming a first focusing element array on the first surface of the transparent substrate;
forming a second focusing element array on the second surface of the transparent substrate;
forming a first image array on or in the transparent substrate in a first image array plane and configured to co-operate with the first focusing element array to exhibit an optically variable effect when viewed from a first side of the security device; and
forming a second image array on or in the transparent substrate in a second image array plane, different from the first image array plane, the second image array being configured to co-operate with the second focusing element array to exhibit an optically variable effect when viewed from a second side of the security device;
wherein at least the first image array is further configured to exhibit a first static macroimage when viewed from the second side of the device.

68. A method of manufacturing a security device according to claim 67, wherein the second image array is further configured to exhibit a second static macroimage when viewed from the first side of the device.
